(19) United States
(12) Patent Application Publication
(10) Pub. No.: US 2017/0357521 A1
(43) Pub. Date: Dec. 14, 2017

(54) VIRTUAL KEYBOARD WITH INTENT-BASED, DYNAMICALLY GENERATED TASK ICONS

(71) Applicant: Microsoft Technology Licensing, LLC, Redmond, WA (US)

(72) Inventors: Timothy S. Paek, Sammamish, WA (US); Cole R. Benson, Seattle, WA (US); Asela J. Gunawardana, Seattle, WA (US); Zachary D. Oligschlaeger, Seattle, WA (US); Alisher Saydalikhodjayev, Seattle, WA (US)

(73) Assignee: Microsoft Technology Licensing, LLC, Redmond, WA (US)

(21) Appl. No.: 15/181,073

(22) Filed: Jun. 13, 2016

(51) Int. Cl. G06F 9/44; G06F 3/0482; G06F 3/0488; G06F 3/0485; G06F 3/0486; G06F 3/0481

(52) U.S. Cl. CPC G06F 9/4446; G06F 3/0486; G06F 3/04817; G06F 3/04883; G06F 3/04886; G06F 3/0485; G06F 3/0482

(57) ABSTRACT

Systems, methods, and computer media for intent-based, dynamic generation and display of task icons within virtual keyboards are provided herein. A system can include a processor, an intent classifier, and a user interface generator. The intent classifier can be configured to determine user intent candidates based on contextual information. A user interface generator can be configured to generate the virtual keyboard for display and, upon receiving an indication of a user intent determined based on the user intent candidates, generate a task icon within the virtual keyboard. The task icon represents functionality associated with the determined user intent. Interaction with the task icon in the virtual keyboard can launch functionality associated with the determined intent.

### BACKGROUND

With the advent of touchscreens and mobile devices, virtual keyboards have become commonplace. Virtual keyboards are typically displayed, for example, when a user taps the screen to enter text while using an application on a touchscreen device. Despite their advantages, virtual keyboards are often difficult and cumbersome to use for certain activities.

### SUMMARY

Examples described herein relate to intent-based, dynamic generation and display of task icons within virtual keyboards. An example system can include a processor, an intent classifier, a ranker, and a user interface generator. The intent classifier can be configured to determine, by the processor, one or more user intent candidates based on contextual information. Contextual information can be, for example, text entered via a virtual keyboard, information relating to an application that is active while the virtual keyboard is displayed, text received in a conversation in the active application, etc.

User intent candidates can be selected in different ways. For example, a ranker can be configured to, by the processor, rank the one or more user intent candidates, and based on the ranking, select a user intent candidate as a determined user intent. A user interface generator can be configured to, by the processor, generate the virtual keyboard for display. Upon receiving an indication of the determined user intent, the user interface generator can also be configured to generate a task icon within the virtual keyboard based on the determined user intent. The task icon can be displayed, for example, in the input method editor (IME) of the virtual keyboard. Selection of or other interaction with the task icon in the virtual keyboard can launch functionality associated with the determined intent. User intent can be updated based on additional contextual information, and the task icon can be removed from the virtual keyboard if the task icon no longer reflects the updated user intent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the claimed subject matter will become more apparent from the following detailed description, which proceeds with reference to the accompanying figures.

### BRIEF DESCRIPTION OF THE DRAWINGS

FIG. 1 is a block diagram of an example system capable of dynamically generating intent-based task icons.

FIG. 2 is a block diagram of an example system capable of dynamically generating intent-based task icons, the system having multiple intent classifiers and a federator.

FIG. 3 is a diagram illustrating an example method of reconfiguring a user interface in which an intent-based task icon is dynamically generated and presented in a virtual keyboard.

FIGS. 4A-4D illustrate determination of intent and presentation of a calendar task icon in a virtual keyboard.

FIG. 5 illustrates determination of intent and presentation of a web services task icon in a virtual keyboard.

FIGS. 6A-6D illustrate determination of intent, presentation of a mapping task icon, and selection of shareable content (a current location and estimated time of arrival) from a task icon user interface.

FIGS. 7A-7D illustrate determination of intent, presentation of a mapping task icon, and selection of shareable content (a link to a restaurant) from a task icon user interface.

FIGS. 8A-8B illustrate determination of intent and presentation of instant answers in the virtual keyboard.

FIGS. 9A-9B illustrate determination of intent and presentation of a media task icon in the virtual keyboard.

FIGS. 10A-10B illustrate determination of intent and presentation of a movie task icon in the virtual keyboard.

FIG. 11 illustrates determination of intent, presentation of a payment task icon in the virtual keyboard, and display of a payment task user interface.

FIGS. 12A-12H illustrate various features related to determination of intent and presentation of a task icon in the virtual keyboard in which a task user interface is presented above the virtual keyboard.

FIGS. 13A-13B illustrate various features related to determination of intent and presentation of a task icon in the virtual keyboard in which a task user interface is presented above the virtual keyboard while a messaging application is active and substantially replaces the messaging application user interface.

FIGS. 14A-14D illustrate various features related to a search tool within the virtual keyboard.

FIGS. 15A-15D illustrate various features related to a search tool within the virtual keyboard in which search category choices are presented.

FIG. 16 illustrates a search tool within the virtual keyboard and a search user interface presented above the virtual keyboard.

FIG. 17 is a flowchart illustrating an example method of reconfiguring a user interface in which an intent-based task icon is dynamically generated and presented in a virtual keyboard and in which a task icon user interface is presented in place of a portion of the user interface.

FIG. 18 is a flowchart illustrating an example method of reconfiguring a user interface including a virtual keyboard in which a task icon user interface is presented in place of a portion of the virtual keyboard.

FIG. 19 is a diagram of an example computing system in which some described embodiments can be implemented.

FIG. 20 is an example mobile device that can be used in conjunction with the technologies described herein.

FIG. 21 is an example cloud-supported environment that can be used in conjunction with the technologies described herein.

### DETAILED DESCRIPTION

Using the systems, methods, and computer-readable media described herein, an intent of a user interacting with a user interface of a computing device can be dynamically determined based on contextual information (e.g., text entered by the user or received from another user), and a task icon reflecting the user intent can be generated and displayed within a virtual keyboard in the user interface. Interaction with the task icon can cause a task icon user interface to be displayed in place of a portion of the overall user interface (e.g., displayed above the virtual keyboard or in place of a portion of the virtual keyboard). The task icon user interface provides convenient access (e.g., via an application user interface, links, deep links, etc.) to functionality corresponding to the user intent.

Unlike conventional approaches, the dynamic, intent-based approaches described herein allow users to access desired functionality directly from the virtual keyboard and/or task icon user interface without forcing the user to exit an application, open another application to perform an action, and then switch back to the original application.

As an example, the described approaches can be used to determine user intent while a user is having a conversation in a messaging application. In an example conversation, the user receives “feel like grabbing a bite to eat?” The user then enters, via a virtual keyboard, “sure, where?” One or both of these questions can be analyzed to determine that the user intent is to find a restaurant at which to meet for dinner. After this user intent is determined, a mapping task icon is generated and presented in the virtual keyboard. A selection, swipe, or other interaction with the mapping task icon causes a mapping task icon user interface to be displayed. The mapping task icon user interface can show locations of nearby restaurants, provide links to webpages of the restaurants, provide shareable restaurant information (e.g., a name and address that can be inserted into the messaging conversation), etc.

Thus, the mapping task icon user interface provides the user with access to mapping functionality (searching for restaurants near the user's current location) without the user having to exit the messaging application, launch a mapping application, locate restaurants, copy information, switch back to the messaging application, etc. The user can simply select a restaurant from the mapping task icon user interface, causing the restaurant's information to be added to the conversation, and continue with the uninterrupted flow of conversation.

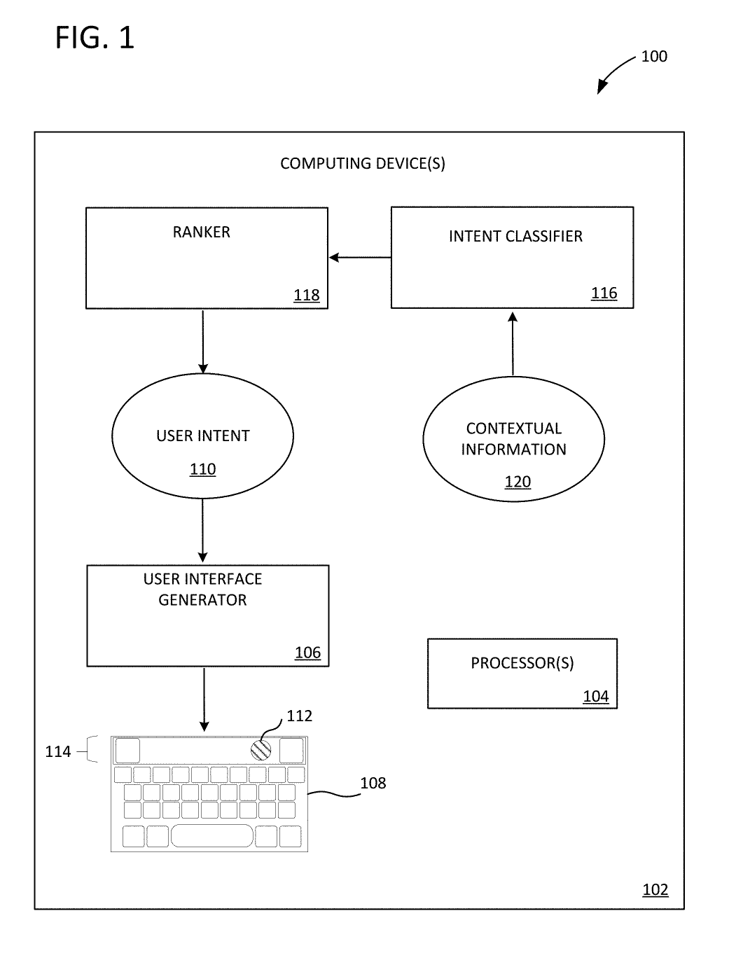

In the described examples, the computational complexity of performing a desired action is reduced through the dynamic, intent-based approaches, which eliminates the computational cost of exiting/launching/relaunching applications and navigating through a user interface to locate desired applications. Examples are described below with reference to FIGS. 1-21.

FIG. 1 illustrates a system 100 implemented on one or more computing device(s) 102. Computing device 102 includes at least one processor 104. Computing device 102 can be, for example, a mobile device, such as a smartphone or tablet, a personal computer, such as a desktop, laptop, or notebook computer, or other device.

A user interface generator 106 is configured to, by the at least one processor 104, generate a virtual keyboard 108 for display in a user interface. The user interface is presented on a display of computing device(s) 102. As used herein a “virtual keyboard” refers to a user interface having numbers, letters, etc. corresponding to those of a physical keyboard (e.g., a laptop or PC keyboard). Typically, the characters of a virtual keyboard are arranged similarly to those of a physical keyboard. The virtual keyboard is typically displayed on a touchscreen, and individual characters are selected through touch selection, hover selection, or other interaction with the touchscreen. Projection keyboards, AirType keyboards, and other non-physical keyboards are also considered to be virtual keyboards.

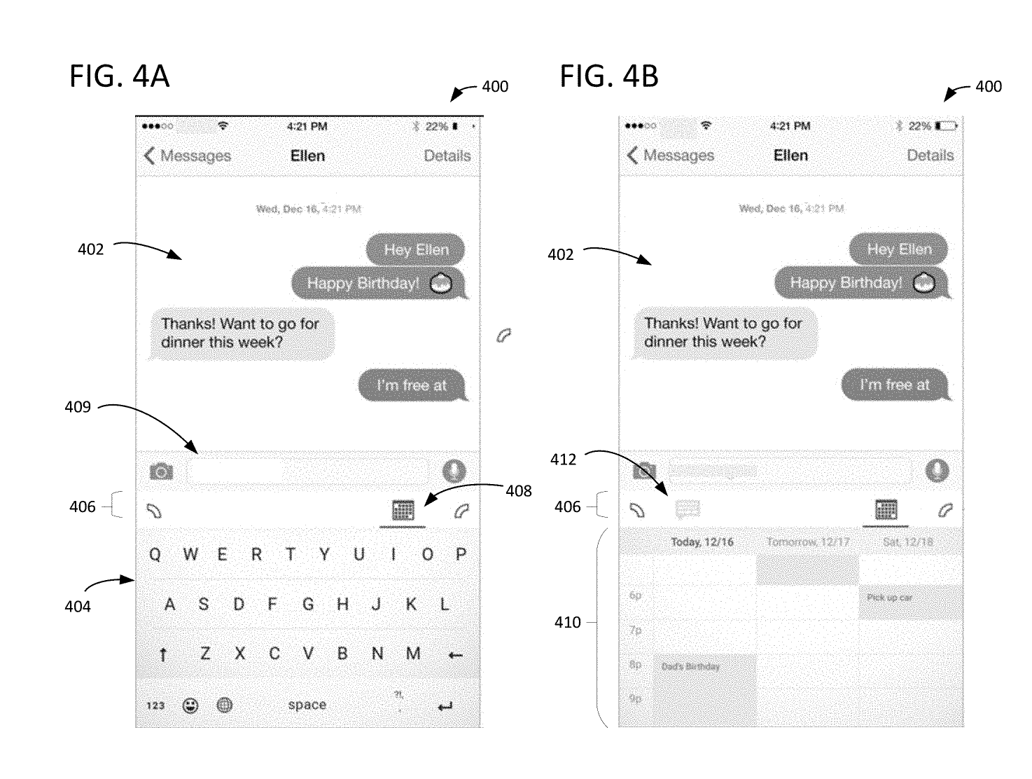

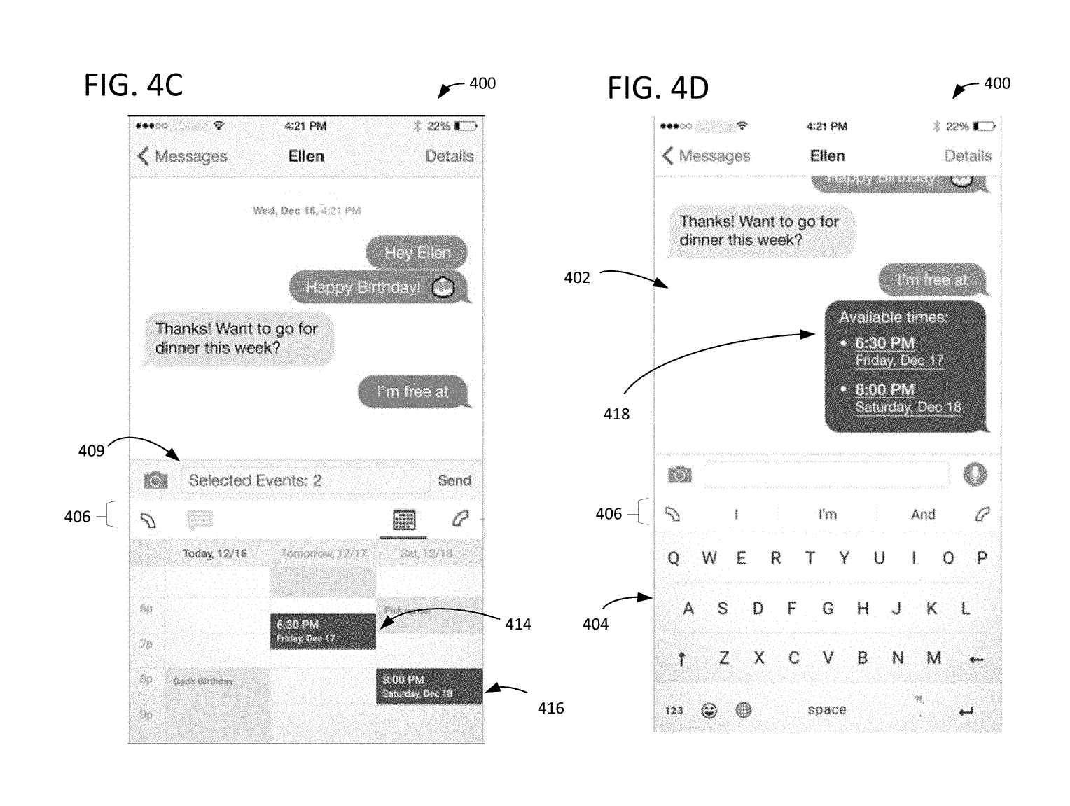

User interface generator 106 is also configured to, by the at least one processor 104 and upon receiving an indication of a determined user intent 110, generate a task icon 112 within virtual keyboard 108 based on determined user intent 110. As used herein, a “task icon” refers to a graphic, image, text, symbol, or other user interface element that represents functionality. The appearance of task icon 112 can reflect determined user intent 110. For example, if determined user intent 110 is to see a movie, task icon 112 can be a graphic or image of a movie studio, theater, ticket, or projector, the text “movies,” etc. In some examples, multiple user intents are determined (e.g., multiple user intents that exceed a confidence or probability threshold), and multiple task icons are presented. Examples of task icons are shown in FIGS. 4A-15.

In some examples, task icon 112 is presented in the input method editor (IME) portion 114 of virtual keyboard 108. IME portion 114 is shown in FIG. 1 as being at the top of virtual keyboard 108. IME portion 114 can be the portion of virtual keyboard 108 where autocorrect or word suggestions are displayed. IME portion 114 can contain various positions of importance. Using the example of autocorrect suggestions appearing in the IME, a most likely suggestion can be presented in IME portion 114 on the left in a first position, a second most likely suggestion can be presented to the right of the first position in a second position, etc. Task icon 112 can be presented in any position within IME portion 114. Task icon 112 can also be presented in a different portion of virtual keyboard 108, such as the left or right side, bottom left or right, etc. Task icon 112 can also be partially occluded as a “peek” of additional information which can be obtained with a swipe. In some examples, user interface generator 106 is further configured to, by the at least one processor 104, remove task icon 112 upon receiving an indication that determined user intent 110 has been updated (e.g., based on additional contextual information or after a time threshold has elapsed).

Interaction with task icon 112 in virtual keyboard 108 launches functionality associated with determined user intent 110. Interaction with task icon 112 can be, for example, a touch or hover selection, swipe to the right (or left, up, or down), pinch, select and hold for a threshold amount of time, or other interaction.

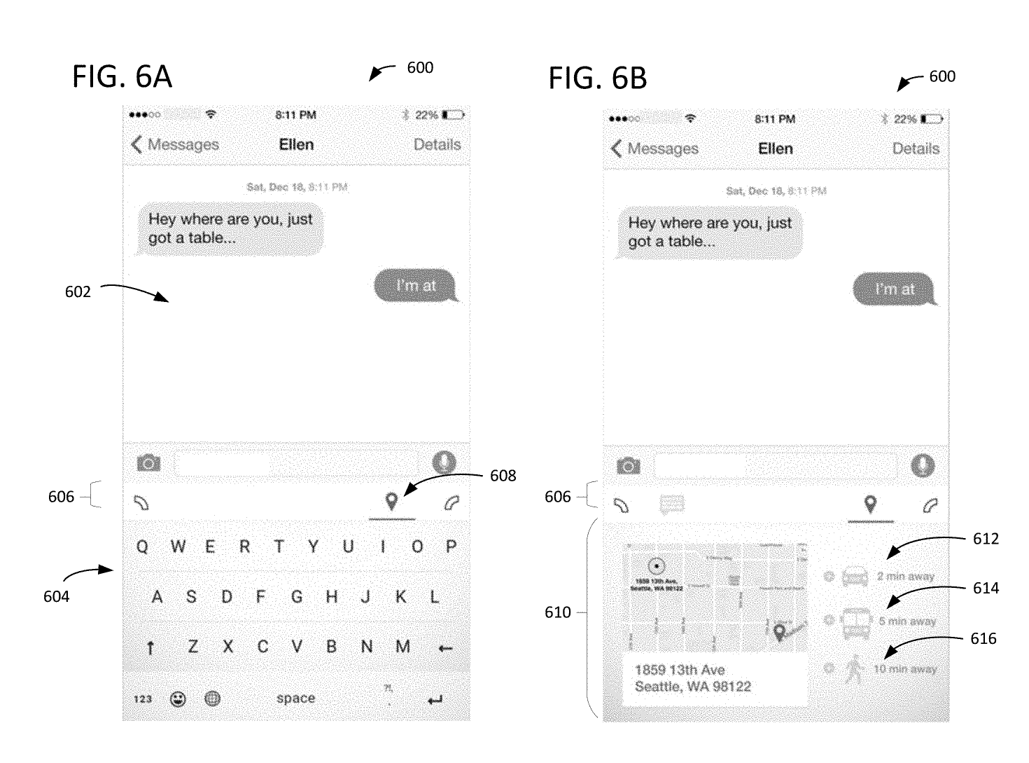

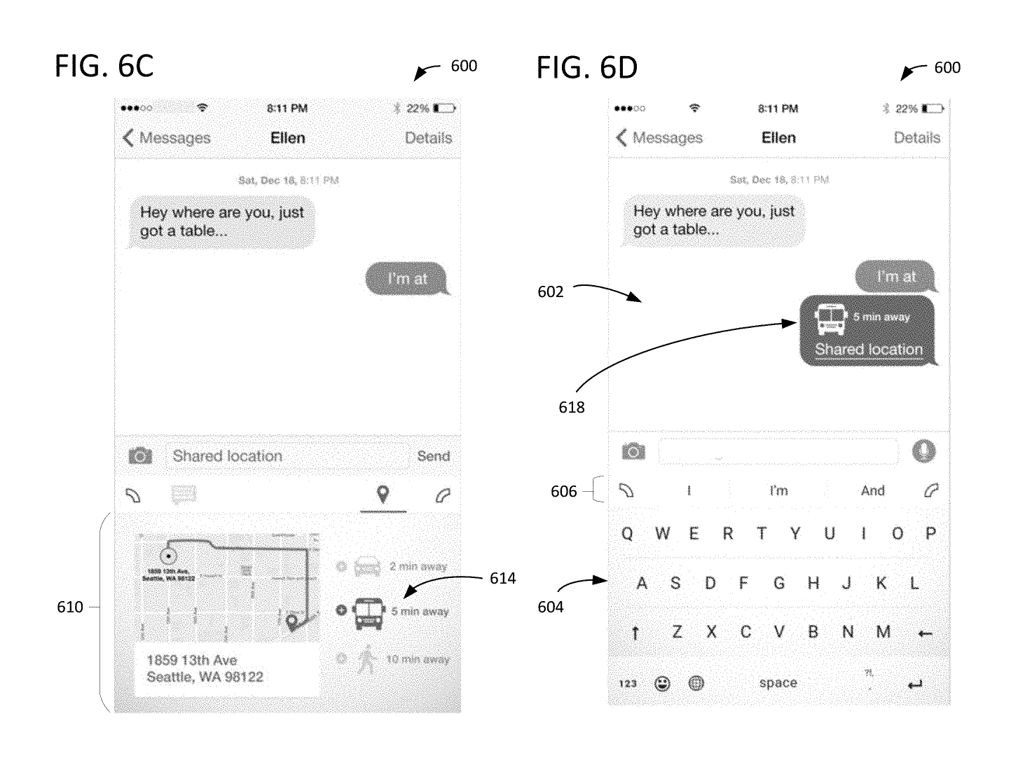

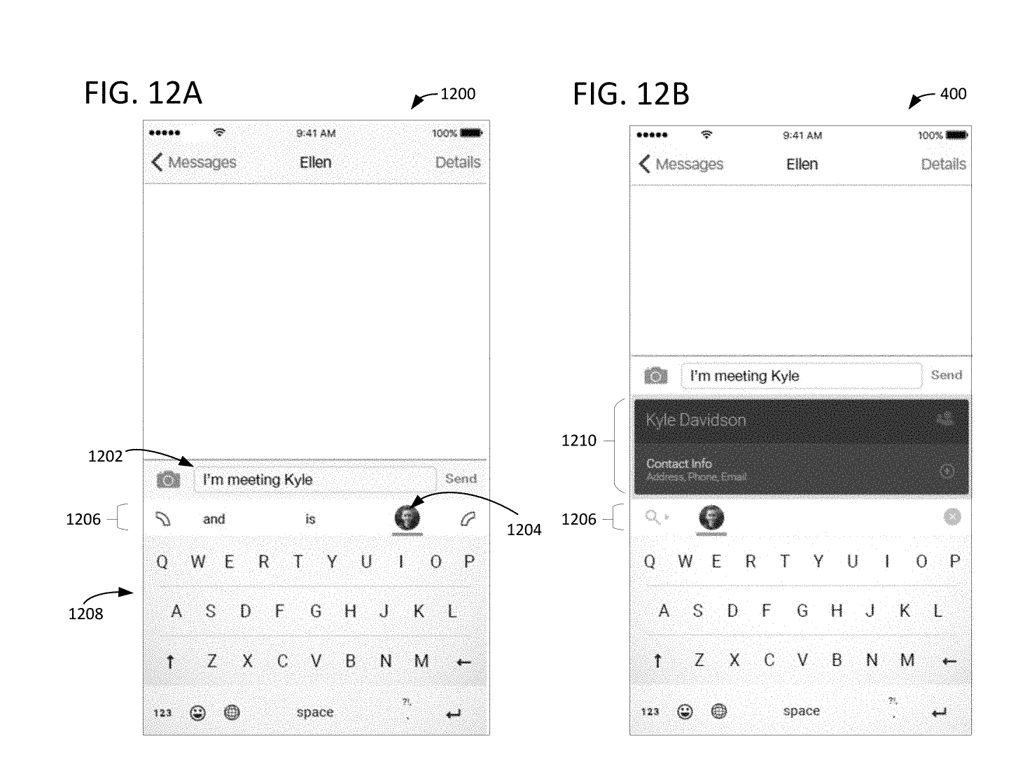

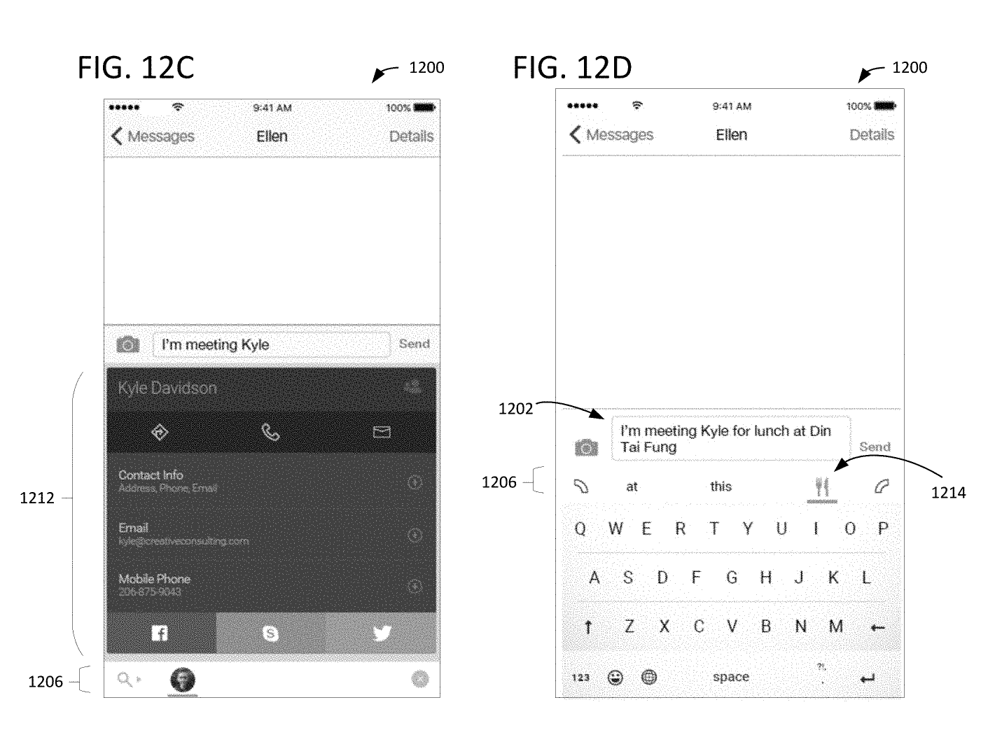

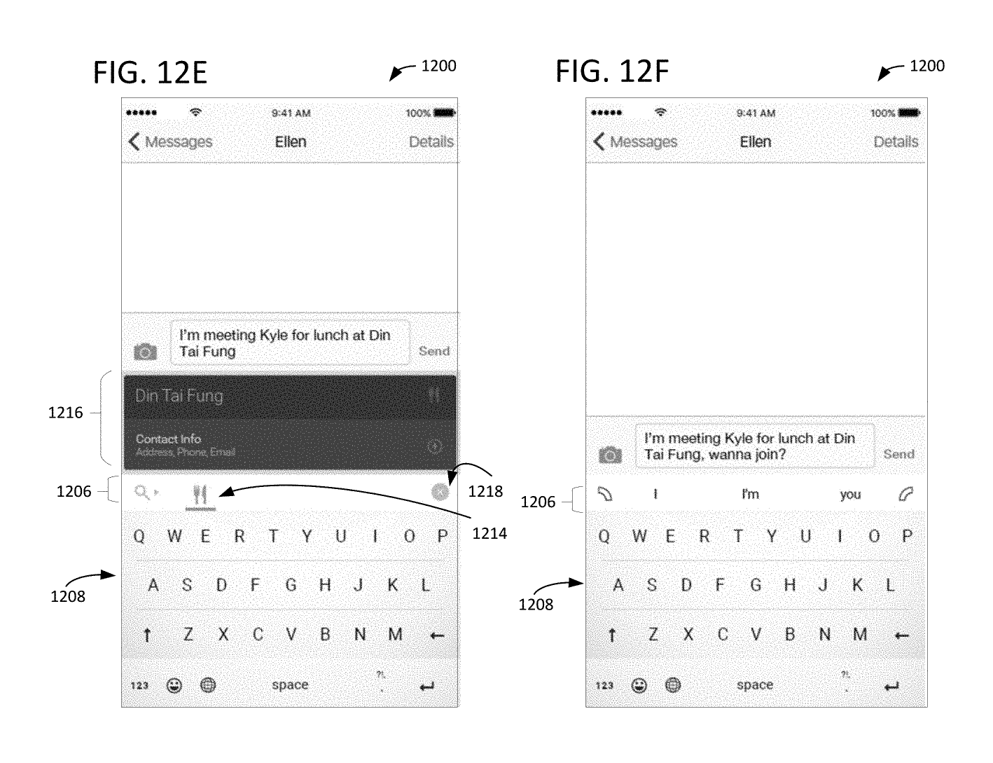

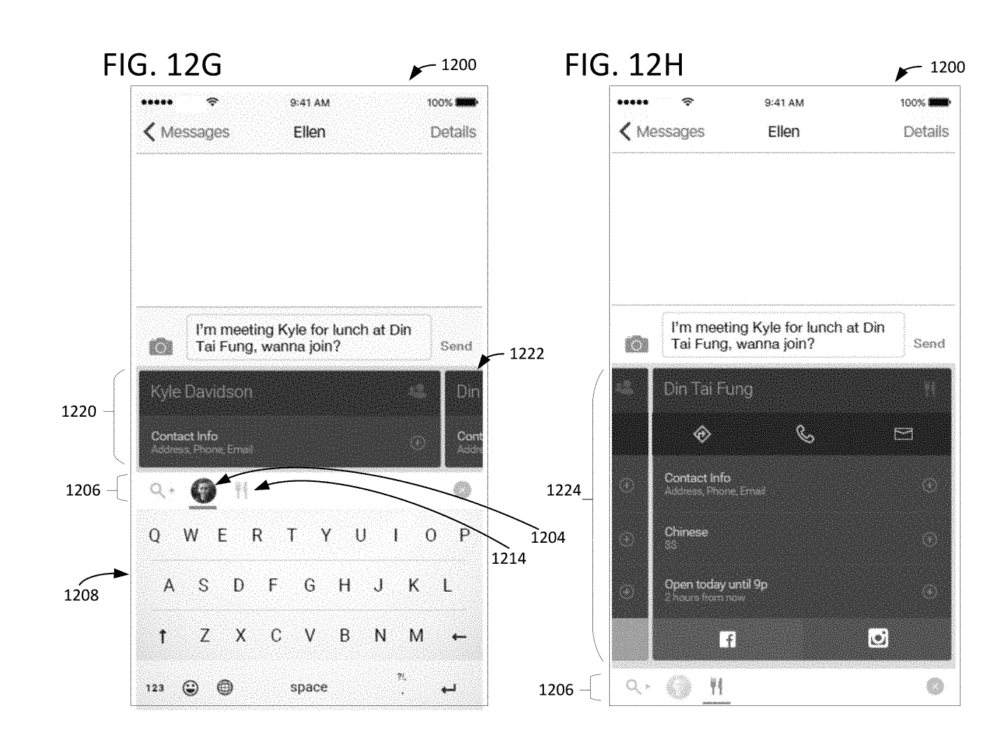

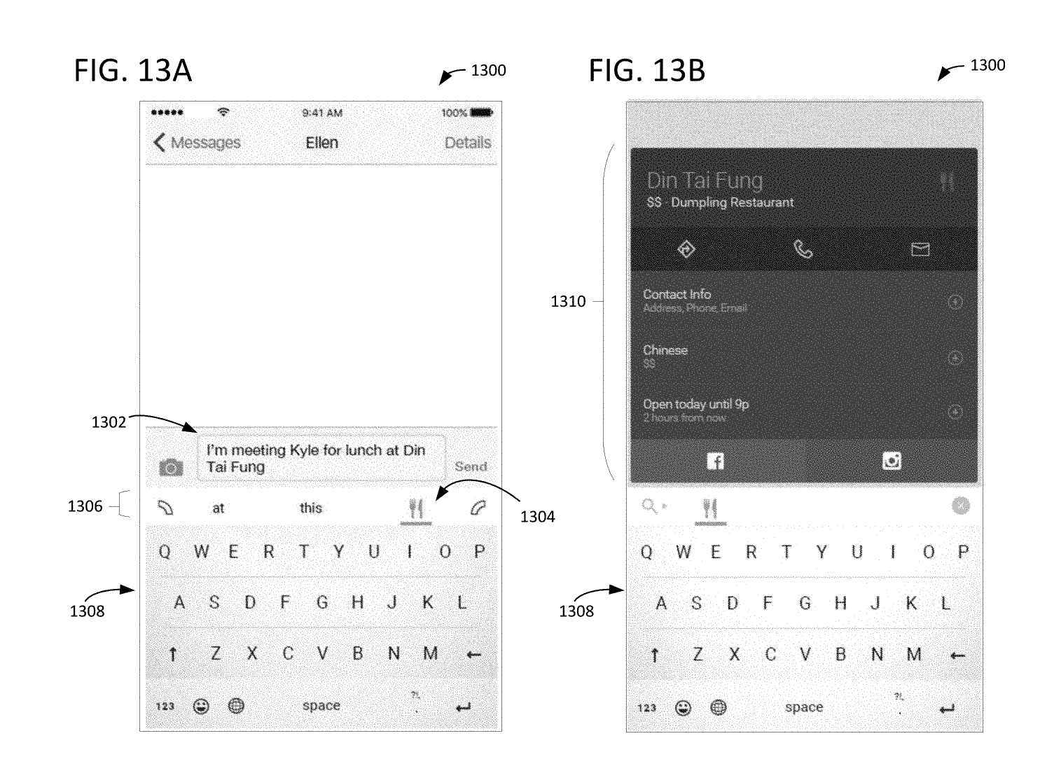

User interface generator 106 can be configured to launch the functionality associated with determined user intent 110 in a task icon user interface (illustrated, e.g., in FIGS. 4B, 6B, 7B, 8D, 9B, 12G, 12H, 13B and other figures). For example, user interface generator 106 can be configured to, upon receiving an indication of an interaction with task icon 112, replace a portion of the user interface with a task icon user interface. The functionality associated with determined user intent 110 is accessible via the task icon user interface. In some examples, the task icon user interface is displayed in place of a portion of virtual keyboard 108. As a specific example, the task icon user interface can be displayed in place of the portion of virtual keyboard 108 below IME portion 114 (illustrated, e.g., in FIGS. 4B and 6B). In some examples, a portion of the user interface other than virtual keyboard 108 is replaced with the task icon user interface. This is illustrated, for example, in FIGS. 12B and 13B. In various examples, virtual keyboard 108 can continue to be displayed while the task icon user interface is displayed.

The task icon user interface can include an application user interface for an application launched by interaction with task icon 112 or a link or deep link to functionality of an application or functionality of a web service. The application launched by interaction with task icon 112 can be, for example, a mapping application, an organization application, a funds transfer application, a media application (audio, video, and/or image), or a user review application. In some examples, the application user interface for the application launched by interaction with task icon 112 comprises shareable content generated by the application and related to determined user intent 110. Shareable content can include, for example, an estimated arrival or departure time, an event start time or end time, a restaurant suggestion, a movie suggestion, a calendar item, a suggested meeting time or meeting location, transit information, traffic information, weather or temperature information, or an instant answer result. Task icon user interfaces are discussed in detail with respect to FIGS. 4B-15.

User interface generator 106 can be implemented, for example, as computer-executable instructions (e.g., software) stored in memory (not shown) and executable by the at least one processor 104. User interface generator 106 can also be implemented at least in part using programmable logic devices (PLDs) such as field programmable gate arrays (FPGAs), application-specific integrated circuits (ASICs), or other computing hardware.

The determined user intent 110 that is provided to user interface generator 106 is determined by an intent classifier 116 and, in some examples, a ranker 118. Intent classifier 116 is configured to determine, by the at least one processor 104, one or more user intent candidates based on contextual information 120. In some examples, system 100 includes multiple intent classifiers. Contextual information 120 can include, for example, text entered via virtual keyboard 108, text received from a remote computing device, commands received through voice recognition, information relating to an application that is active while virtual keyboard 108 is displayed, task icons previously interacted with, a location of a user interacting with the user interface, a current time, day, or date, or history or preference information.

As an example, if a messaging application is active while virtual keyboard 108 is displayed, contextual information 120 can include: messages entered via virtual keyboard 108; messages received from another user; the fact that the messaging application is active; preferences or history associated with the other user with whom the user is communicating; or preferences or history associated with conversations between the two users (e.g., a history of the two users meeting for coffee). Contextual information 120 can also include actions recently performed by the user (e.g., a recent search for “coffee” in a mapping application), reminders/alarms, calendar or organizer items (e.g., “have coffee with Kyle” stored as an upcoming appointment in a calendar application), etc. As used herein, a messaging application includes dedicated “chat” applications, chat or messaging functionality in other applications, email applications, or other applications in which messages are sent between users.

Intent classifier 116 can determine user intent candidates through a number of approaches, including artificial intelligence and machine learning approaches such as natural language understanding (NLU). NLU involves parsing, organizing, and classifying human language (whether received through voice recognition, touch/type input, or received in an electronic message or other electronic communication). NLU can be performed, for example, using a template matching approach in which text is analyzed to identify particular co-located strings that correspond to a known intent. For example, a template of “(airport_code_1) to (airport_code_2)” can correspond to an intent to purchase airline tickets. In template matching approaches, received text can be compared to a number of different templates.

Intent classification can also be performed through the use of statistical models such as logistic regression, boosted decision trees, neural networks, conditional Markov language models or conditional random fields. In such approaches, a training set of text portions that are tagged with a known intent are used to build statistical models that are then used to predict the intent of other text encountered at run-time. Collecting a variety and large amount of training data can improve the performance of such approaches.

In some examples, system 100 includes different intent classifiers for different types of functionality that can be associated with and accessed via task icon 112. For example, system 100 can include an intent classifier for restaurant recommendations, an intent classifier for directions, an intent classifier for media items, etc. In examples where template matching techniques are used, different intent classifiers can have different associated templates. Intent classifier 116 can be trained using training data based on previously entered text and subsequent actions taken (for the user and/or for other users). For example, if a user receives the text “Hungry?” and replies “starving,” and then opens a restaurant review or mapping application, this data can be used as training data to match future received incidences of “hungry” and “starving” with the intent to find a restaurant at which to eat. Training can also be done based on user interactions with, or lack of user interactions with, previously presented task icons. For example, if a task icon is presented based on a determined intent, and the user selects, swipes, or otherwise interacts with the task icon, an interpretation is that the determined user intent was accurate for the contextual information. Conversely, if a task icon is presented but not interacted with by the user, an interpretation is that the determined user intent was not accurate. In some examples, training data can be aggregated across users and stored, for example, in a cloud environment where the training data can be accessed by different users. In other examples, training data is user specific.

A search tool can also be used to train intent classifier 116. User searches and corresponding subsequent actions taken or results selected are used to inform future intent classification. The search tool (illustrated, e.g., in FIGS. 13A-13D, 14A-14D, 15A-15D, and 16) can be included in virtual keyboard 108. The search tool can be presented, for example, in IME portion 114, and can be accessed by interacting with a search icon (e.g., a magnifying glass, question mark, etc.) or by performing a particular gesture or combination of gestures. For example, a swipe of IME portion 114 (e.g., swipe left or right) can cause the search tool having a text entry area to be displayed in IME portion 114. A swipe of IME 114 in an opposite direction or selection of an exit button can cause the search tool to disappear. The search tool can also be a speech recognition search tool that begins “listening” when a search icon is interacted with. In some examples, the search tool is displayed when virtual keyboard 108 is displayed. As a specific example, when virtual keyboard 108 is launched, the search tool appears in or under IME portion 114. In some examples where the search tool is presented in IME portion 114, when task icon 112 is generated and presented (or when autocorrect suggestions are generated) due to use of the application with which virtual keyboard 108 is being used, the search tool disappears. System 100 can include a search engine (not shown) configured to perform searches received via the search tool, and user interface generator 106 can be configured to present the search tool.

Intent classifier 116 can be implemented, for example, as computer-executable instructions (e.g., software) stored in memory (not shown) and executable by the at least one processor 104. Intent classifier 116 can also be implemented at least in part using programmable logic devices (PLDs) such as field programmable gate arrays (FPGAs), application-specific integrated circuits (ASICs), or other computing hardware. Intent classifier 116 can also be implemented using neural networks (e.g., deep neural networks, convolutional neural networks, etc.). In some examples, intent classifier 116 can be implemented in a cloud computing environment (e.g., such as cloud 2110 of FIG. 21), and system 100 is in communication with intent classifier 116 through a network such as the Internet. In some examples, some functionality of intent classifier 116 can be implemented in system 100 while other functionality of intent classifier 116 is implemented in the cloud.

In some examples intent classifier 116 performs ranking of or otherwise selects (e.g., selects a candidate with a highest probability, etc.) one or more of the user intent candidates as determined user intent 110. In other examples, ranker 118 is configured to, by the at least one processor 104, rank the one or more user intent candidates determined by intent classifier 116 and, based on the ranking, select at least one user intent candidate as determined user intent 110. Ranker 118 can be configured to apply a variety of ranking approaches, such as to select a user intent candidate with a highest confidence level (e.g., probability of being correct). In some examples, the functionality of ranker 118 is combined with intent classifier 116. Ranking can be done, for example, by calibrating intent classifier 116 using isotonic or logistic regression and then sorting by classifier outputs, using boosted decision trees or neural networks trained under ranking loss functions, or other approaches. Selection of determined user intent 110 can be done, for example, by thresholding the scores used for ranking.

Ranker 118 can be implemented, for example, as computer-executable instructions (e.g., software) stored in memory (not shown) and executable by the at least one processor 104. Ranker 118 can also be implemented at least in part using programmable logic devices (PLDs) such as field programmable gate arrays (FPGAs), application-specific integrated circuits (ASICs), or other computing hardware.

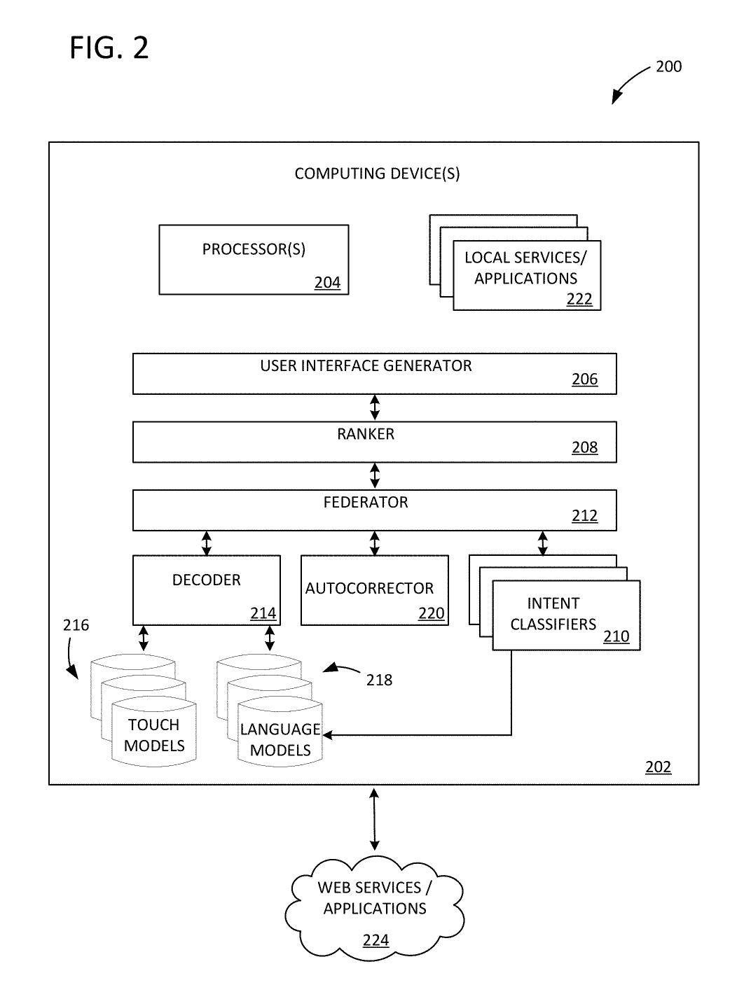

FIG. 2 illustrates a system 200 implemented on one or more computing device(s) 202. Computing device 202 includes at least one processor 204. Computing device 202 can be similar to computing device 102 of FIG. 1. User interface generator 206 and ranker 208 can also be similar to the corresponding components in FIG. 1. System 200 includes multiple intent classifiers 210. A federator 212 is configured to, by the at least one processor 204, distribute contextual information to intent classifiers 210. Federator 212 is also configured to determine an aggregated group of user intent candidates based on the user intent candidates determined by intent classifiers 210. Ranker 208 is further configured to, by the at least one processor 204, rank the user intent candidates in the aggregated group.

User interface generator 206, ranker 208, and federator 212 can be implemented, for example, as computer-executable instructions (e.g., software) stored in memory (not shown) and executable by the at least one processor 204. User interface generator 206, ranker 208, and federator 212 can also be implemented at least in part using programmable logic devices (PLDs) such as field programmable gate arrays (FPGAs), application-specific integrated circuits (ASICs), or other computing hardware.

Decoder 214 is configured to, by the at least one processor 204, interpret and recognize touch and hover input to the virtual keyboard (not shown). Decoder 214 can be configured to recognize touches/taps as well as swipes. Decoder 214 can be configured to interpret input according to one or more touch models 216 and language models 218 (e.g., such as a user's language model). Touch models 216 are configured to evaluate how well various hypotheses about which word a user intends, as the user is entering text, match the touch and hover input. Language models 218 are configured to evaluate how well these hypotheses fit words already entered. Autocorrector 220 is configured to, by the at least one processor 204, provide autocorrect suggestions, spelling suggestions, etc., that can be presented, for example, in the IME of the virtual keyboard.

Similar to user interface generator 106 of FIG. 1, user interface generator 206 is configured to generate a task icon, within the virtual keyboard, reflecting a determined user intent, and upon receiving an indication of an interaction with the task icon, generate a task icon user interface providing access to functionality corresponding to the determined intent. The task icon user interface can include links or deep links to one or more local services or applications 222 or web services or applications 224. The task icon user interface can also include an application interface for the one or more local services or applications 222 or web services or applications 224.

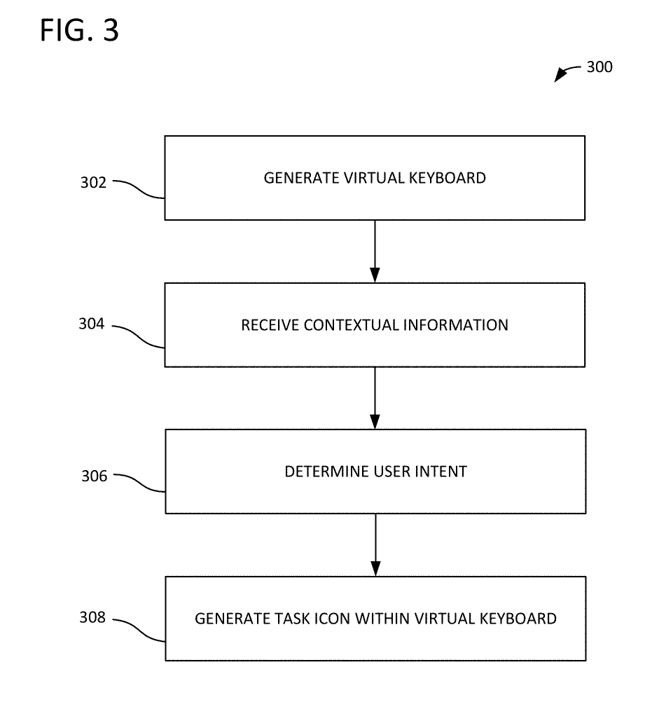

FIG. 3 illustrates an example method 300 of reconfiguring a user interface. In process block 302, a virtual keyboard is generated. In process block 304, contextual information is received. Contextual information can include, for example, text entered via the virtual keyboard, text received from a remote computing device, commands received through voice recognition, or information relating to an application that is active while the virtual keyboard is displayed. A user intent is determined in process block 306. User intent can be determined, for example, using an intent classifier and ranker. In process block 308, a task icon is generated within the virtual keyboard. The task icon can be presented in the IME of the keyboard, for example. Method 300 can be performed, for example, using system 100 of FIG. 1 or system 200 of FIG. 2.

FIGS. 4A-4D illustrate determination of user intent and presentation of a calendar task icon. In user interface 400 of FIG. 4A, a messaging application is active and a conversation 402 is displayed. User interface 400 also includes a virtual keyboard 404 having an IME portion 406. Based on contextual information obtained from conversation 402 (e.g., the question “Want to go for dinner this week?” and the response “I'm free at”), a user intent to identify an available time to meet for dinner is determined. Contextual information can also include, for example, whether or not “Ellen” is a frequent contact (and is therefore someone with whom it is more likely the user would meet up for dinner), the user's statement “Happy Birthday” and accompanying birthday cake emoji, whether an email indicated Ellen would be in the same location as the user, etc. After this intent is determined, a task icon 408 is generated and presented in IME portion 406 of virtual keyboard 404. A text entry box 409 is also shown in user interface 400. Text entry box 409 is part of the messaging application and is not a part of virtual keyboard 404.

As shown in FIG. 4B, interaction with task icon 408 (such as a selection, swipe to the left or right, etc.) causes a task icon user interface 410 to be presented in place of a portion of user interface 400. In FIG. 4B, task icon user interface 410 is presented in place of a portion of virtual keyboard 404. Specifically, the portion of virtual keyboard 404 below IME portion 406 has been replaced by task icon user interface 410, but IME portion 406 remains displayed. The portion of user interface 400 in which conversation 402 is displayed remains unchanged. The functionality associated with the determined intent is accessible via task icon user interface 410. Task icon user interface 410 includes an application user interface of a calendar application in which blocks of time for different days are shown. The appearance of task icon 408 (a month view of a calendar) reflects the determined user intent and the functionality that can be launched in task icon user interface 410 by interacting with task icon 408. Task icon 408 can be accentuated (e.g., underlined and bolded as shown in FIGS. 4A and 4B, distorted, or otherwise emphasized) to indicate that interaction with task icon 408 launches functionality. A keyboard icon 412 is presented in IME portion 406 to allow the user to replace task icon user interface 410 with the character keys of virtual keyboard 404. In task icon user interface 410, blocks of time are selectable and can be added to conversation 402 as shown in FIGS. 4C and 4D.

In FIG. 4C, two possible times, time block 414 and time block 416, have been selected. Text entry box 409 indicates “Selected Events:2.” Time block 414 and 416 are shareable content that can be selected and added to conversation 402. By taking another action (such as pressing “Send,” dragging and dropping, etc.) an “Available times:” conversation entry 418 including the times of time block 414 and time block 416 is added to conversation 402 as shown in FIG. 4D. After conversation entry 418 has been added, task icon 408 is no longer displayed in IME portion 406. As FIGS. 4A-4D illustrate, dynamic determination of user intent and generation and presentation of a task icon corresponding to the user intent allow the user to perform actions and access other applications without interrupting the flow of a conversation.

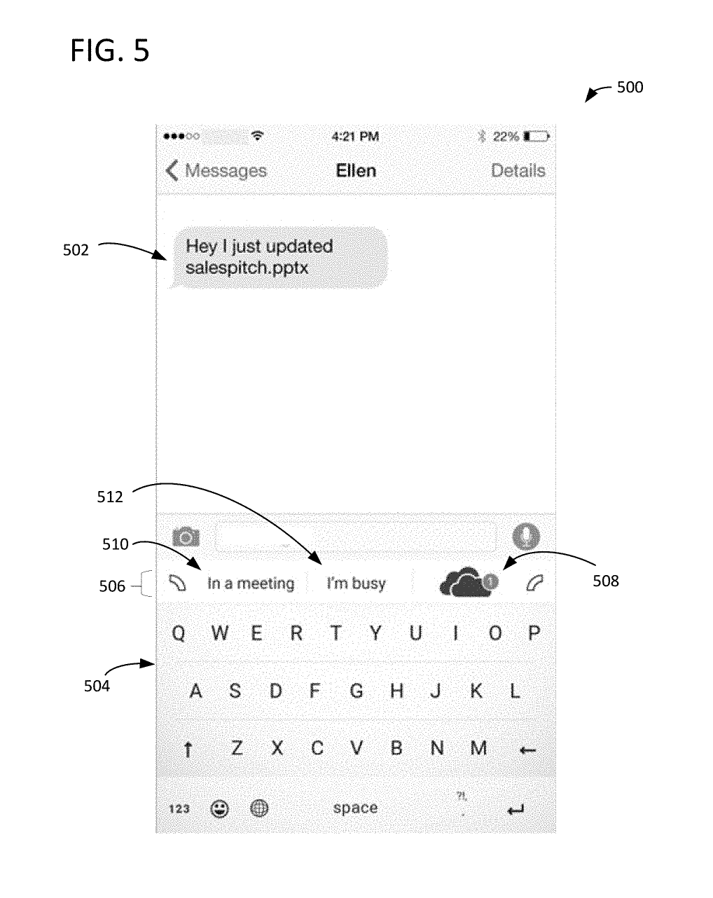

FIG. 5 illustrates a user interface 500 that includes a conversation 502 being conducted in a messaging application. A virtual keyboard 504 includes an IME portion 506. A user intent to open a file from a web service is determined based on the statement “Hey I just updated salespitch.pptx” in conversation 502. A web service task icon 508 is presented in IME portion 506, along with autosuggestions 510 (“In a meeting”) and 512 (“I'm busy”). In FIG. 5, autosuggestion 510 is in IME position one, autosuggestion 512 is in IME position two, and task icon 508 is in IME position three. Interaction with task icon 508 launches functionality associated with the web service (not shown), such as a link or deep link to the “salespitch.pptx” file, to a shared work area or file folder, a web service user interface, etc.

FIG. 6A illustrates a user interface 600 that includes a conversation 602 being conducted in a messaging application. A virtual keyboard 604 includes an IME portion 606. A user intent to share a current location (and/or to provide an estimated time of arrival, etc.) is determined based on the statements “Hey where are you, just got a table . . . ” and/or “I'm at” in conversation 602. A mapping task icon 608 is then presented in IME portion 606 to reflect the determined intent. Interaction with mapping task icon 608 causes mapping task icon user interface 610 to be presented in place of a portion of virtual keyboard 604, as shown in FIG. 6B.

Mapping task icon user interface 610 includes a map of the user's current location and destination as well as shareable content items 612, 614, and 616 that indicate the user's estimated time of arrival by car, bus, or walking, respectively. In FIG. 6C, shareable content item 614 has been selected (as indicated by the bolding of shareable content item 614), and the bus route taken between the current location of the user and the destination is shown in mapping task icon user interface 610. In FIG. 6D, conversation entry 618 has been added to conversation 602. Conversation entry 618 reflects shareable content item 614.

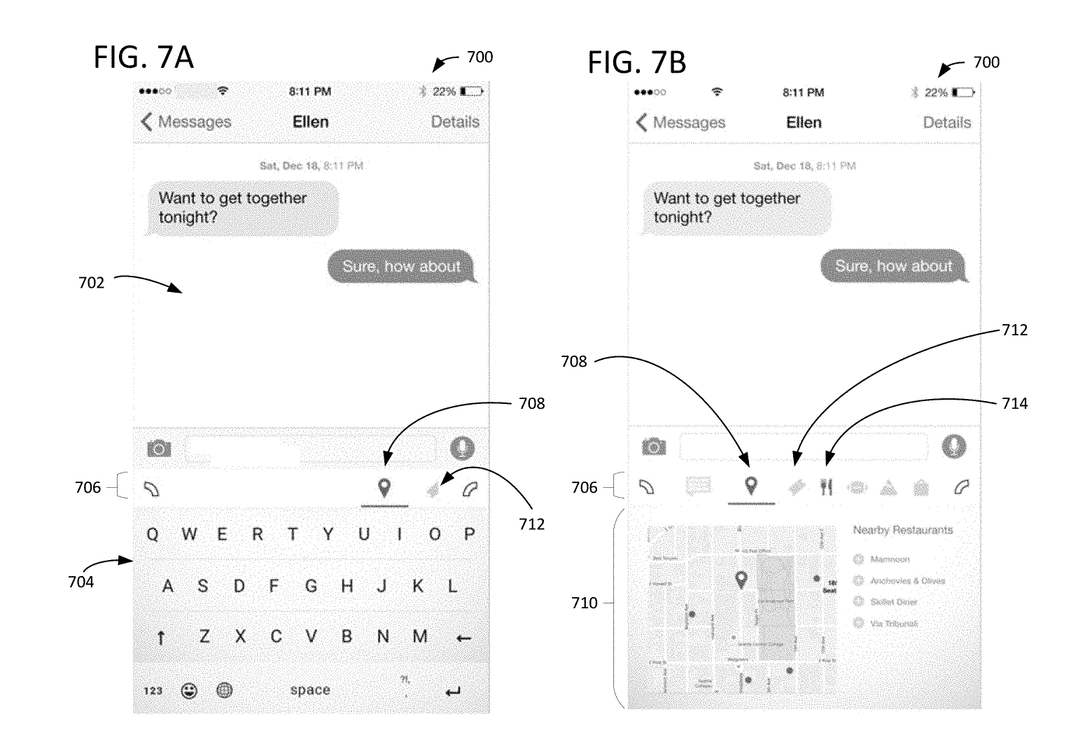

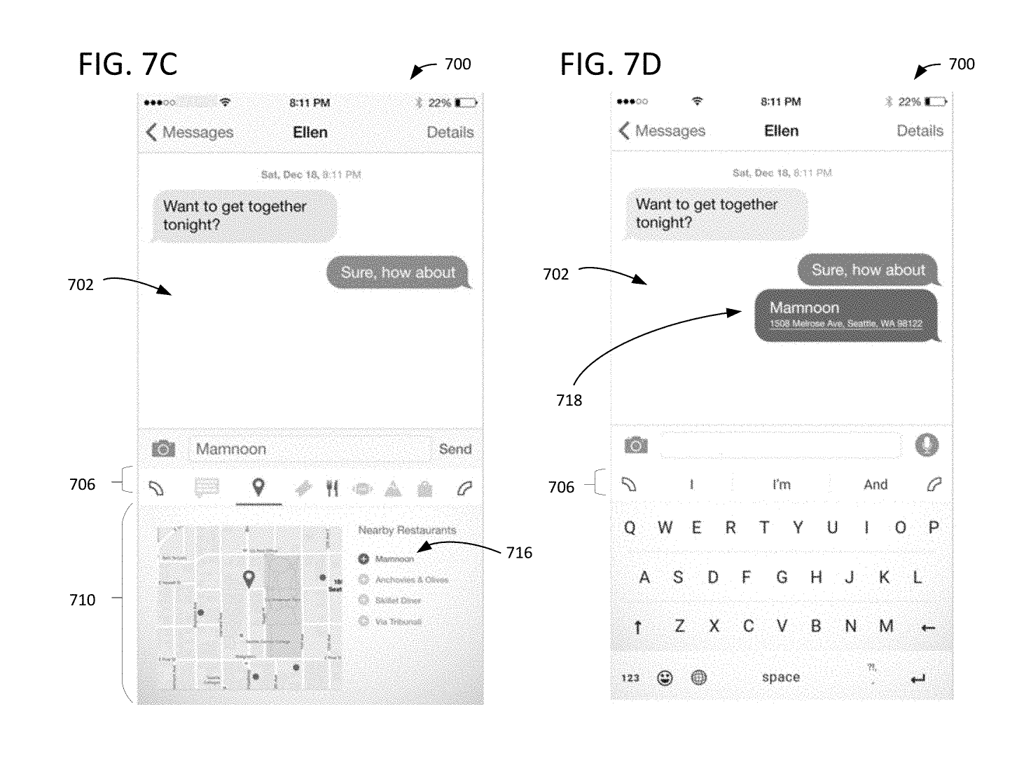

FIG. 7A illustrates a user interface 700 that includes a conversation 702 being conducted in a messaging application. A virtual keyboard 704 includes an IME portion 706. A user intent to meet at a location (e.g., for dinner at a restaurant) is determined based on the statements “Want to get together tonight?” and/or “Sure, how about” in conversation 702. A mapping task icon 708 is presented in IME portion 706. Interaction with mapping task icon 708 causes mapping task icon user interface 710 to be presented in place of a portion of virtual keyboard 704, as shown in FIG. 7B. Mapping task icon user interface 710 displays the user's current location and lists nearby restaurants.

As shown in FIGS. 7A and 7B, IME portion 706 also includes additional task icons generated based on contextual information, such as movie task icon 712, which is partially obscured in FIG. 7A but is visible in FIG. 7B. In some cases, multiple user intents are possible. Based on the statements in conversation 702, a user might be interested in meeting for dinner, meeting for coffee, meeting for a movie, meeting to return an item, etc. As a result, multiple task icons can be generated and presented within virtual keyboard 704. The multiple task icons can be presented in an order of likelihood determined, for example, based on confidence level, user history, etc. As shown in FIG. 7B, mapping task icon 708, movie task icon 712, restaurant task icon 714 and other task icons are presented in IME portion 706.

In some examples, a first task icon can be associated with other task icons representing a subset of functionality of the first task icon. For example, mapping task icon 708 can launch a variety of different mapping functionality (e.g., estimated time of arrival, location of restaurants, location of stores, etc.). Accordingly, as illustrated in FIG. 7B, mapping task icon 708 has been selected, and mapping task icon user interface 710 is associated with the restaurant aspect of mapping represented by restaurant task icon 714. In user interface 700, a user can swipe or select other task icons to change the task icon user interface that is displayed below IME portion 706.

In FIG. 7C, a shareable content item 716 (the restaurant “Mamnoon”) has been selected (as indicated by the bolding of shareable content item 716). In FIG. 7D, a conversation entry 718 has been added to conversation 702. Conversation entry 702 reflects shareable content item 718 and lists the name and address of the restaurant. The task icons, including task icons 708 and 712, have been removed from IME portion 706 after conversation entry 702 was added.

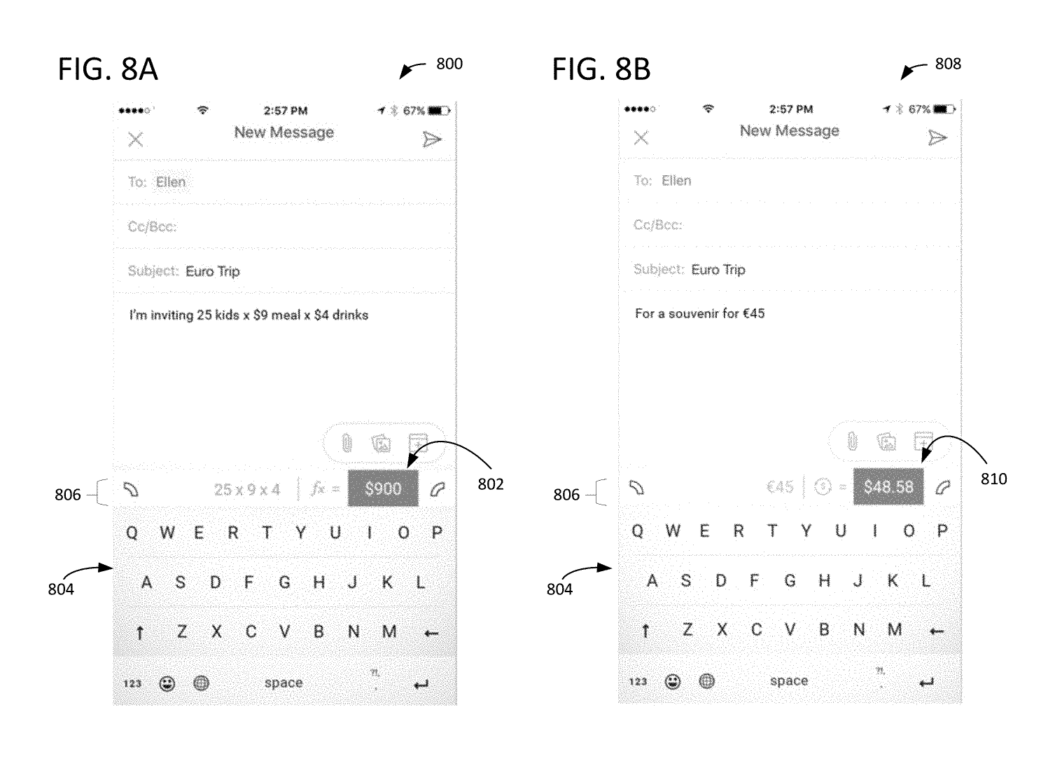

FIGS. 8A and 8B relate to intent-based instant answers. In user interface 800 of FIG. 8A, a new message is being composed (e.g., in an email or messaging application) that includes the text “I'm inviting 25 kids x $9 meal x $4 drinks.” Some or all of this text can be used to determine a user intent of calculating a total cost. An instant answer result 802 indicating the total cost is displayed within IME portion 804 of virtual keyboard 806. Similarly, in user interface 808 of FIG. 8B, a new message is being composed that includes the text “For a souvenir for ε45.” Some or all of this text can be used to determine a user intent of calculating a U.S. dollar equivalent price. An instant answer result 810 indicating the U.S. dollar price is displayed within IME portion 804 of virtual keyboard 806.

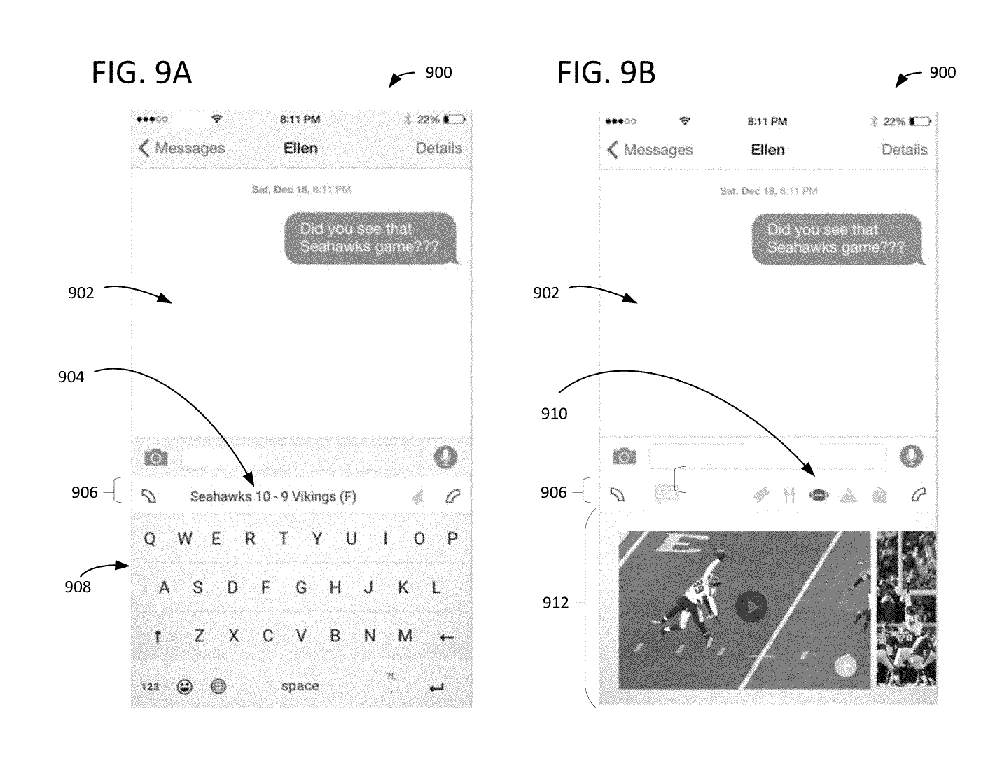

FIGS. 9A and 9B illustrate a user interface 900 in which a conversation 902 is displayed. Based on contextual information (e.g., the conversation entry “Did you see that Seahawks game???”) a user intent to view or share a video of a Seattle Seahawks football game is determined. An instant answer result 904 of a recent game score is provided in IME portion 906 of virtual keyboard 908. One or more task icons can also be generated and displayed in virtual keyboard 908, as is illustrated in FIG. 9B. Additional task icons can be revealed, for example, by swiping instant answer result 904. FIG. 9B shows multiple task icons including football media task icon 910, which when interacted with causes a replacement of a portion of virtual keyboard 908 with football media task user interface 912, which displays shareable and/or viewable football game video clips and/or images. A user, for example, can select or drag and drop a thumbnail image of a video clip into conversation 902.

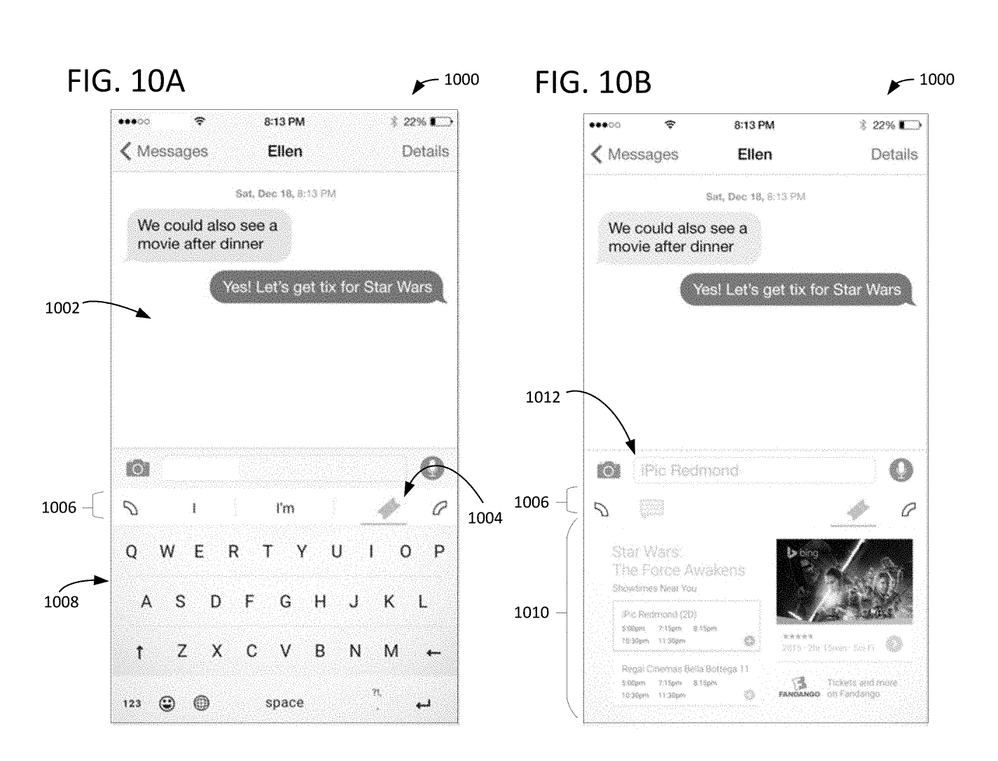

FIGS. 10A and 10B illustrate a user interface 1000 in which a conversation 1002 is displayed. Based on contextual information (e.g., the conversation entries “We could also see a movie after dinner” and/or “Yes! Let's get tix for Star Wars”) a user intent to go see the movie “Star Wars” is determined. A movie task icon 1004 is presented in IME portion 1006 of virtual keyboard 1008. Interaction with movie task icon 1004 causes movie task icon user interface 1010 to be presented in place of a portion of virtual keyboard 1008, as shown in FIG. 10B. Movie task icon user interface 1010 displays show times for “Star Wars” at theaters near the user's current locations. Movie task icon user interface 1010 can be a movie ticket purchase/reservation service application user interface and/or can contain links to a movie service or deep links to purchase tickets for a particular show. In FIG. 10B, the theater “iPic Redmond (2D)” is selected and appears as a text entry in text entry box 1012. This text entry can then be added to conversation 1002.

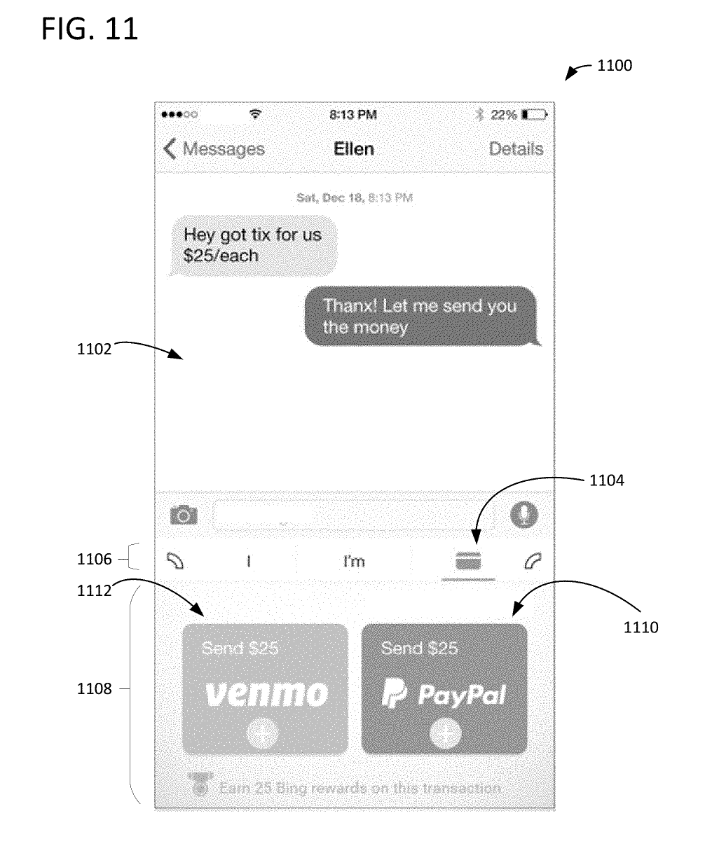

FIG. 11 illustrates a user interface 1100 in which a conversation 1102 is displayed. Based on contextual information (e.g., the conversation entries “Hey got tix for us $25/each” and/or “Thanx! Let me send you the money”) a user intent to transfer funds is determined. A funds transfer is considered a transaction service; a transactional service application can be a funds transfer application or other transaction-based application. A funds transfer task icon 1104 is presented in IME portion 1106 of a virtual keyboard (only IME portion 1106 is shown in FIG. 11). FIG. 11 also shows a funds transfer task icon user interface 1108 that replaced a portion of the virtual keyboard after interaction with funds transfer task icon 1104. Funds transfer task icon user interface contains deep links 1110 and 1112 that can be selected to transfer funds using different funds transfer services. An indication that funds were sent can then be added to conversation 1102.

FIGS. 12A-12H illustrate examples in which a task icon user interface replaces a portion of the overall user interface (above the virtual keyboard) rather than replacing a portion of the virtual keyboard. FIG. 12A illustrates a user interface 1200 in which “I'm meeting Kyle” has been entered into a text entry box 1202 of a messaging application. Based on contextual information (e.g., the text entry “I'm meeting Kyle”) a user intent to access contact information for Kyle is determined. A contacts task icon 1204 is presented in IME portion 1206 of virtual keyboard 1208. Interaction with task icon 1204 causes a portion of user interface 1200 (the portion immediately above IME portion 1206) to be replaced with a contacts task icon user interface 1210, as shown in FIG. 12B. Contacts task icon user interface 1210 comprises functionality of a contacts or organizer application and displays contact information for Kyle.

FIG. 12C illustrates an expanded contacts task icon user interface 1212 that is presented upon interaction with contacts task icon user interface 1210 in FIG. 12C. Expanded contacts task icon user interface 1212 is presented in place of a portion of virtual keyboard 1208 (i.e., in place of the character keys). IME portion 1206 is moved to the bottom of user interface 1200. In FIG. 12C, the portion of user interface 1200 available for displaying messages remains the same as in FIG. 12B before presentation of expanded contacts task icon user interface 1212.

In FIG. 12D, the user has exited expanded contacts task icon user interface 1212 and continued typing in text entry box 1204, which now reads “I'm meeting Kyle for lunch at Din Tai Fung.” An updated user intent of determining/sharing the location of a restaurant is determined based on updated contextual information (the additional text “for lunch at Din Tai Fung”). A restaurant task icon 1214 is displayed in IME portion 1206 to reflect the updated user intent, and contacts task icon 1204 is removed from IME portion 1206. In some examples, task icons that were presented but subsequently removed because of an updated user intent can be represented by an indicator (e.g., a numeral or other indicator in the IME or elsewhere in the virtual keyboard), and these task icons can be redisplayed upon user interaction with the indicator.

In FIG. 12E, a user interaction with restaurant task icon 1214 causes a portion of user interface 1200 to be replaced with a restaurant task icon user interface 1216 that provides contact information for the restaurant “Din Tai Fung.” In FIG. 12F, user interface 1200 reflects that a user has selected exit button 1218 illustrated in FIG. 12E, and restaurant task icon user interface 1216 and restaurant task icon 1214 have disappeared.

In some examples, if a task icon is determined to still reflect a determined user intent after additional contextual information is received but an additional intent is also determined based on the additional contextual information, then an additional task icon can be presented with the original task icon. In FIGS. 12G and 12H, both contacts task icon 1204 and restaurant task icon 1214 are presented in IME portion 1206 based on updated contextual information (the additional text “for lunch at Din Tai Fung, wanna join?”). A user interaction with contacts task icon 1204 causes a contacts task icon user interface 1220 to replace a portion of user interface 1200. In FIG. 12G, multiple task icon user interfaces are present to correspond to the multiple task icons. A portion of a restaurant task icon user interface 1222 is visible next to contacts task icon user interface 1220. The different task icon user interfaces can be scrollable. For example, a user can swipe or scroll contacts task icon user interface 1220 to the left or right or swipe/select restaurant task icon 1214 to display restaurant task icon user interface 1222. FIG. 12H illustrates an example in which restaurant task icon user interface 1222 is selected and then, upon user interaction with restaurant task icon user interface 1222, a portion of virtual keyboard 1208 is replaced by extended restaurant task icon user interface 1224.

FIG. 13A illustrates a user interface 1300 in which “I'm meeting Kyle for lunch at Din Tai Fung” has been entered into a text entry box 1302 of a messaging application. Based on contextual information (e.g., the text entry “I'm meeting Kyle for lunch at Din Tai Fung”) a user intent to access/share restaurant information is determined. A restaurant task icon 1304 is presented in IME portion 1306 of virtual keyboard 1308. Interaction with task icon 1304 causes a portion of user interface 1300 (the portion above IME portion 1206) to be replaced with a restaurant task icon user interface 1310, as shown in FIG. 13B. Virtual keyboard 1308 continues to be displayed when restaurant task icon user interface 1310 is presented.

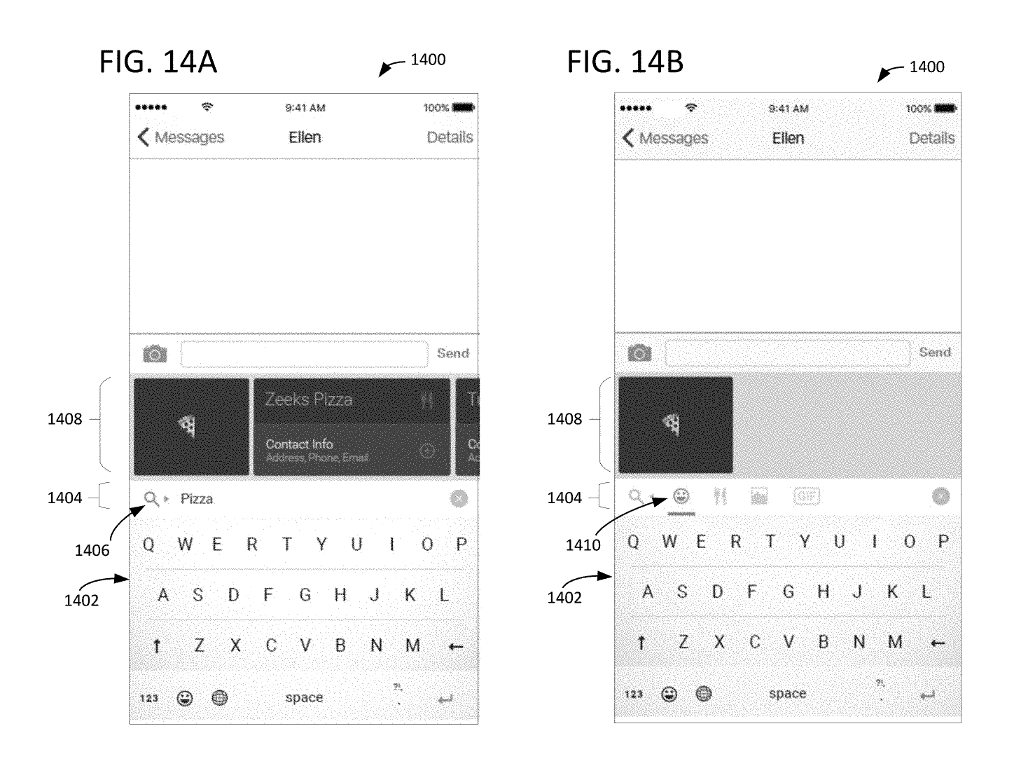

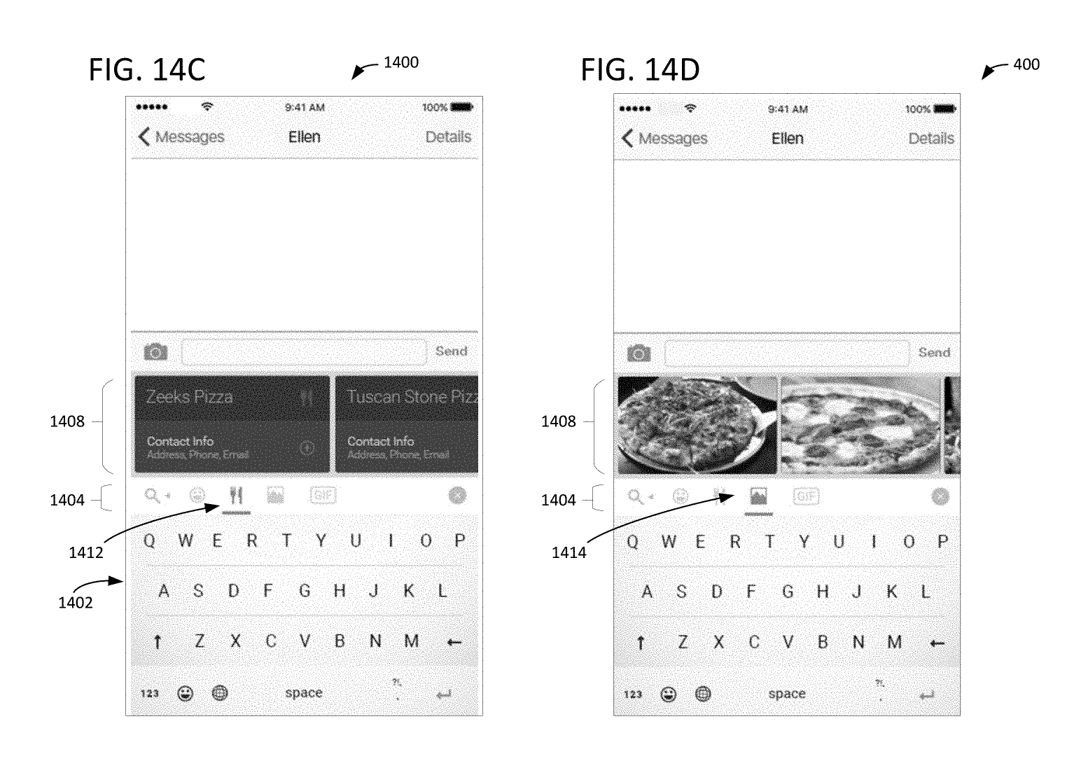

FIGS. 14A-16 illustrate various example user interfaces in which a search tool is presented within a virtual keyboard. In FIG. 14A, user interface 1400 contains a virtual keyboard 1402 having an IME portion 1404. A search tool, represented by a magnifying glass icon 1406 is presented in IME portion 1404. In some examples, the search tool is accessed (and magnifying glass icon 1406 is displayed) by swiping the IME or selecting another icon or character displayed within virtual keyboard 1402. In FIG. 14A, a user has entered “Pizza.” A search result user interface 1408 is then displayed that shows results for various categories such as emoji, restaurants, etc.

In FIG. 14B, different task icons are displayed in IME portion 1404 corresponding to the various categories. In FIG. 14B, an emoji icon 1410 is selected, and search results user interface 1408 displays only emoji results for “pizza.” Emoji icon 1410 is not considered to be a task icon because the emoji is not associated with functionality. In FIG. 14C, a restaurant task icon 1412 is selected, and search results user interface 1408 displays only restaurant results. Similarly, in FIG. 14D, an image task icon 1414 is selected, and search results user interface 1408 displays only image results. As with emoji icon 1410, in some examples, image task icon 1414 is not considered to be a task icon unless functionality is associated with image task icon 1414. Search results user interface 1408 can provide access to functionality (e.g., via links, deep links, or application user interfaces) similar to a task icon user interface.

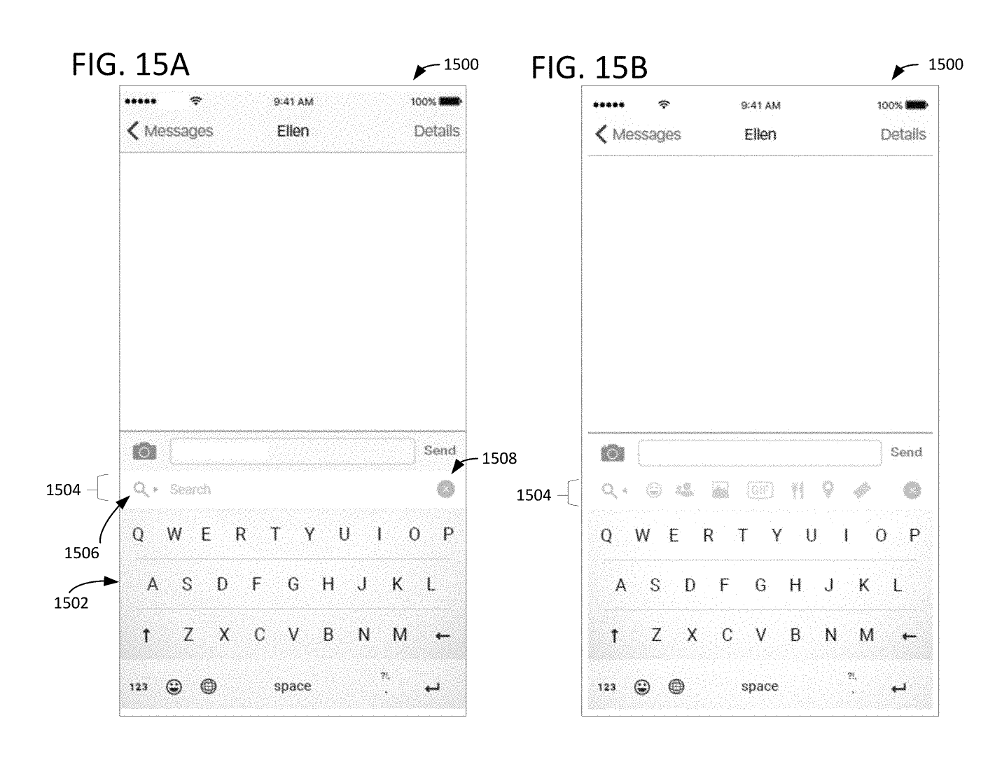

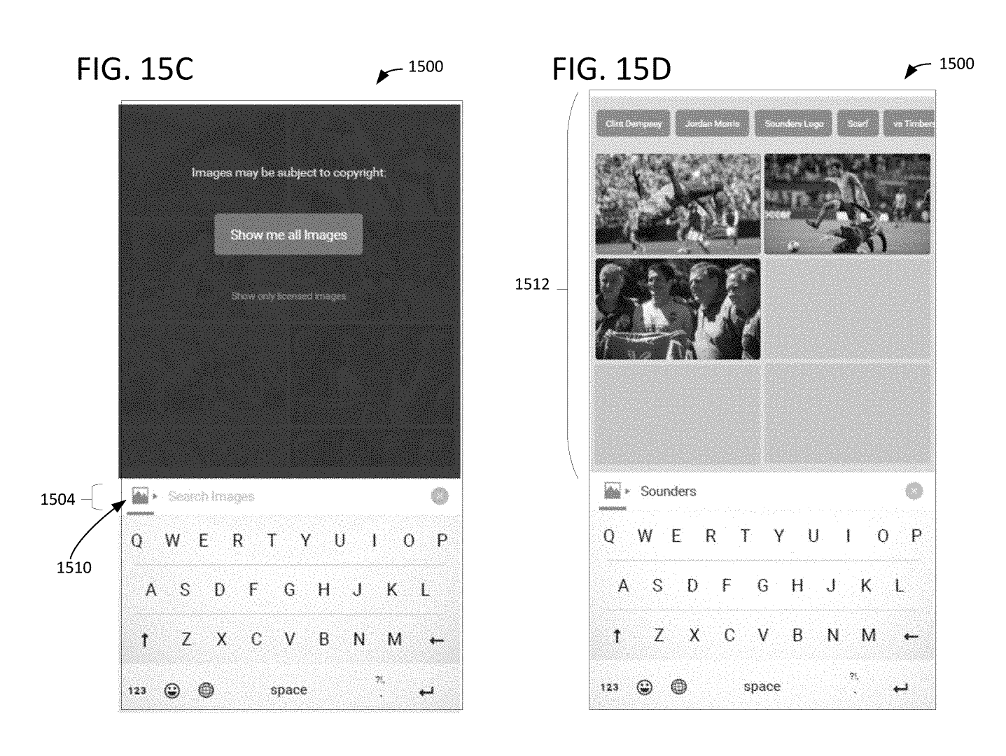

FIG. 15A illustrates an example user interface 1500 including a virtual keyboard 1502 having an IME portion 1504. FIG. 15A illustrates an example of the initial display of a search tool (as represented by magnifying glass icon 1506). The search tool can be presented, for example, after a user swipes or otherwise interacts with IME portion 1504. The search tool can be hidden by selecting exit button 1508. In some examples, the search tool provides an option to select search results that correspond to various categories. FIG. 15B illustrates a variety of task icons corresponding to the various categories presented within IME portion 1504. The category-based search can be an alternative to the arrangement displayed in FIG. 15A, or the arrangements in FIGS. 15A and 15B can be toggled or selected between.

FIG. 15C illustrates a user selection of a particular search category. In FIG. 15C, an image search is selected, as indicated by image task icon 1510 shown in IME portion 1504. In FIG. 15D, “Sounders” is searched for, and a search results user interface 1512 is presented that includes image results.

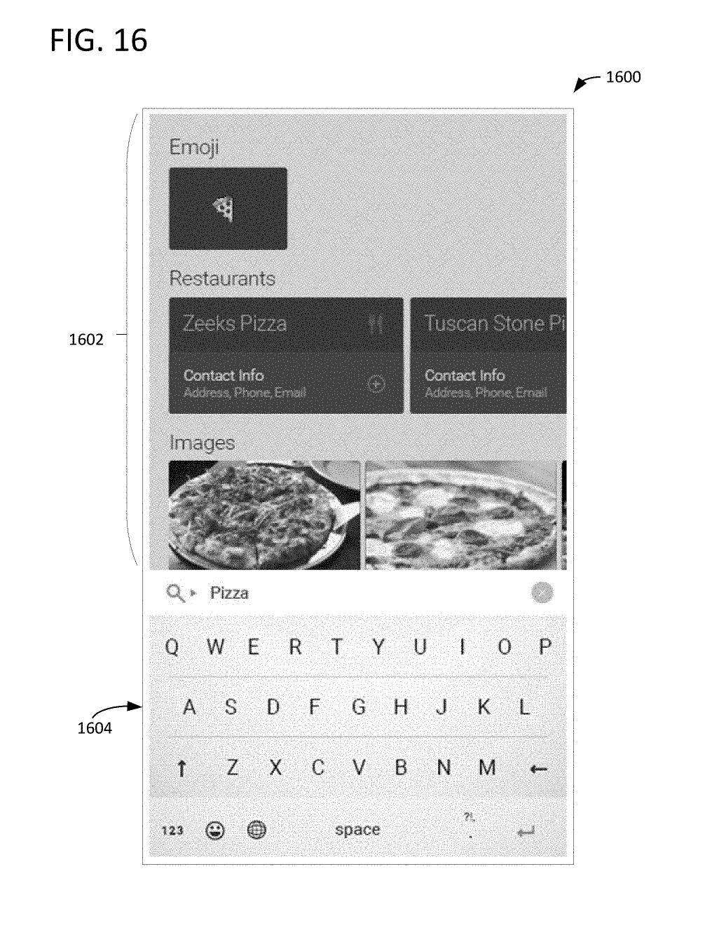

FIG. 16 illustrates a user interface 1600 in which a search results user interface 1602 is presented above a virtual keyboard 1604 in place of a portion of user interface 1600.

In FIGS. 4A through 16, task icon user interfaces, extended task icon user interfaces, and search result user interfaces are presented in different locations and replace different portions of the overall user interface. It is contemplated that any of the positions described herein of the task icon user interfaces can be used with any of the examples. Specific configurations and examples were chosen for explanatory purposes and are not meant to be limiting.

In some examples, task icons are generated and presented based on previous manual searches. For example, task icons corresponding to previous searches entered through a search tool (e.g., in the IME portion of a virtual keyboard) can be presented in the virtual keyboard. In some examples, task icons corresponding to previous searches can be presented before a current user intent is determined.

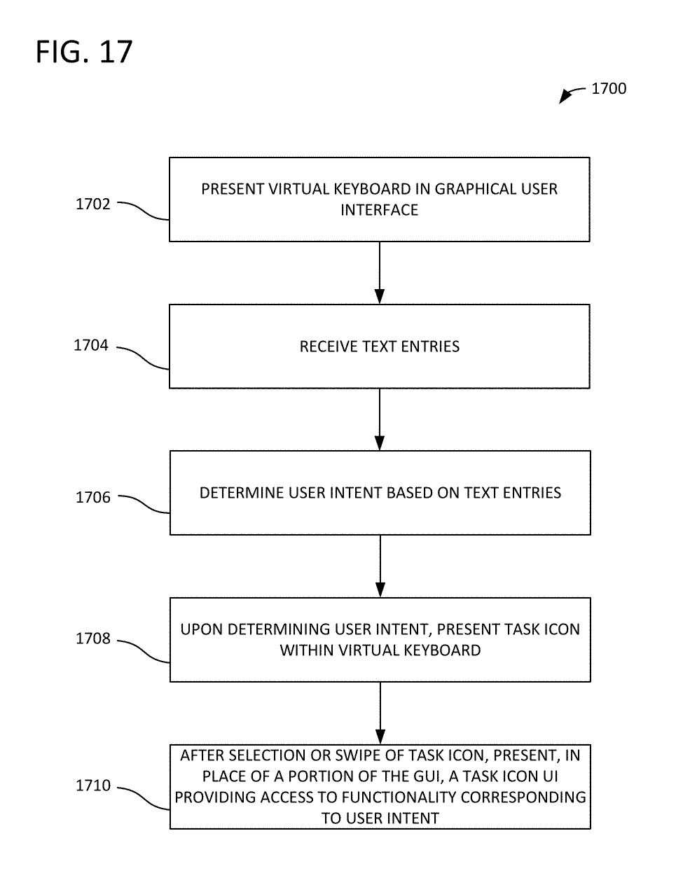

FIG. 17 illustrates a method 1700 for reconfiguring a user interface on a computing device. In process block 1702, a virtual keyboard is presented in the graphical user interface. In process block 1704, one or more text entries are received. In process block 1706, based at least in part on the one or more text entries, a user intent is determined using one or more intent classifiers. Upon determining the user intent, a task icon representing functionality corresponding to the user intent is presented within the virtual keyboard in process block 1708. In process block 1710, after a user selection of the task icon, a task icon user interface that provides access to the functionality corresponding to the user intent is presented in place of a portion of the graphical user interface.

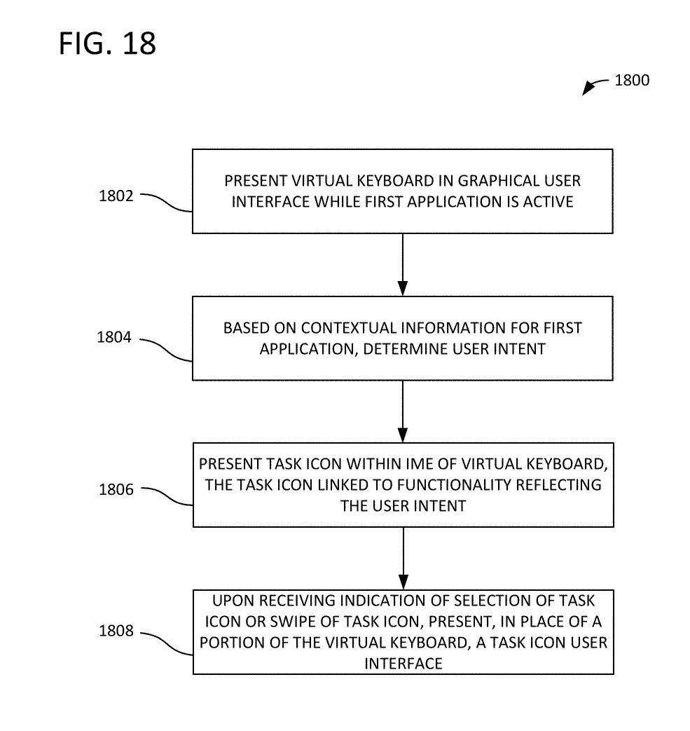

FIG. 18 illustrates a method 1800 for reconfiguring a graphical user interface. In process block 1802, while a first application is active, a virtual keyboard is presented in the graphical user interface. The virtual keyboard has an input method editor (IME) portion. In process block 1804, based at least in part on contextual information for the first application, a user intent is determined. The contextual information includes at least one of text entered via the virtual keyboard, text received via the first application, or information relating to the first application. A task icon is presented within the IME portion of the virtual keyboard in process block 1806. The task icon is linked to functionality reflecting the user intent. In process block 1808, upon receiving an indication of a selection of the task icon, a task icon user interface is presented in place of a portion of the virtual keyboard. The task icon user interface comprises at least one of: an application user interface for a second application, shareable content generated by the second application, or a deep link to functionality of the second application or functionality of a web service.

### Example Computing Systems

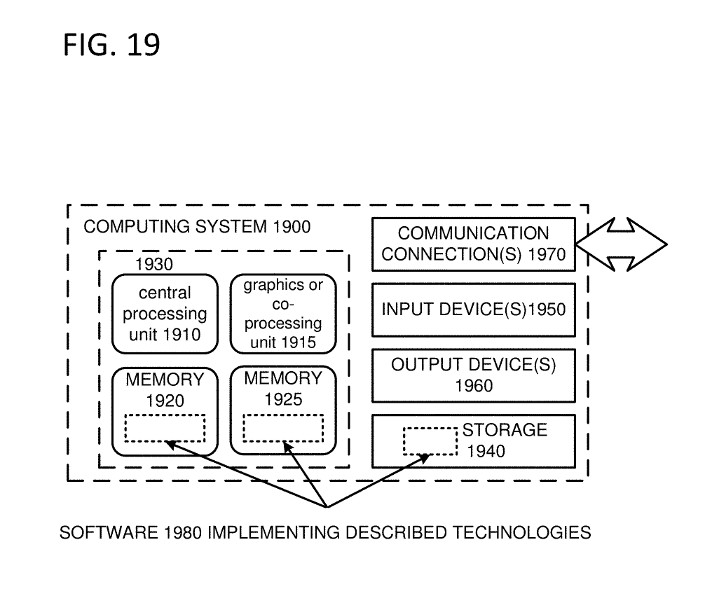

FIG. 19 depicts a generalized example of a suitable computing system 1900 in which the described innovations may be implemented. The computing system 1900 is not intended to suggest any limitation as to scope of use or functionality, as the innovations may be implemented in diverse general-purpose or special-purpose computing systems.

With reference to FIG. 19, the computing system 1900 includes one or more processing units 1910, 1915 and memory 1920, 1925. In FIG. 19, this basic configuration 1930 is included within a dashed line. The processing units 1910, 1915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 19 shows a central processing unit 1910 as well as a graphics processing unit or co-processing unit 1915. The tangible memory 1920, 1925 may be volatile memory (e.g., registers, cache, RAM), non-volatile memory (e.g., ROM, EEPROM, flash memory, etc.), or some combination of the two, accessible by the processing unit(s). The memory 1920, 1925 stores software 1980 implementing one or more innovations described herein, in the form of computer-executable instructions suitable for execution by the processing unit(s). For example, memory 1920, 1925 can store intent classifier 116, ranker 118, and/or user interface generator 106 of FIG. 1 and/or user interface generator 206, ranker 208, federator 212, decoder 214, autocorrector 220, and/or intent classifiers 210 of FIG. 2.

A computing system may have additional features. For example, the computing system 1900 includes storage 1940, one or more input devices 1950, one or more output devices 1960, and one or more communication connections 1970. An interconnection mechanism (not shown) such as a bus, controller, or network interconnects the components of the computing system 1900. Typically, operating system software (not shown) provides an operating environment for other software executing in the computing system 1900, and coordinates activities of the components of the computing system 1900.

The tangible storage 1940 may be removable or non-removable, and includes magnetic disks, magnetic tapes or cassettes, CD-ROMs, DVDs, or any other medium which can be used to store information and which can be accessed within the computing system 1900. The storage 1940 stores instructions for the software 1980 implementing one or more innovations described herein. For example, storage 1940 can store intent classifier 116, ranker 118, and/or user interface generator 106 of FIG. 1 and/or user interface generator 206, ranker 208, federator 212, decoder 214, autocorrector 220, and/or intent classifiers 210 of FIG. 2.

The input device(s) 1950 may be a touch input device such as a keyboard, mouse, pen, or trackball, a voice input device, a scanning device, or another device that provides input to the computing system 1900. For video encoding, the input device(s) 1950 may be a camera, video card, TV tuner card, or similar device that accepts video input in analog or digital form, or a CD-ROM or CD-RW that reads video samples into the computing system 1900. The output device(s) 1960 may be a display, printer, speaker, CD-writer, or another device that provides output from the computing system 1900.

The communication connection(s) 1970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example Mobile Devices

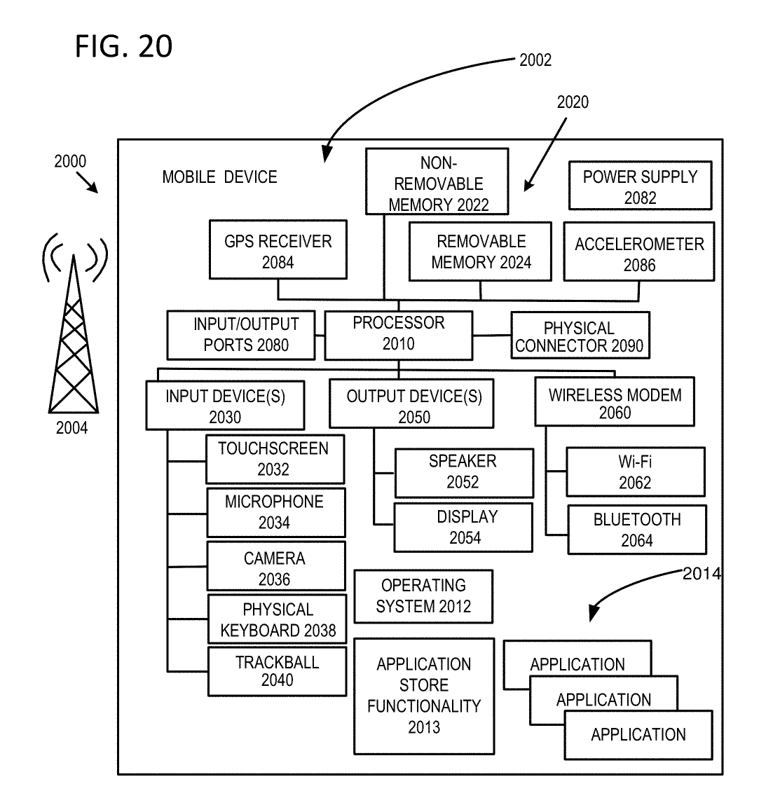

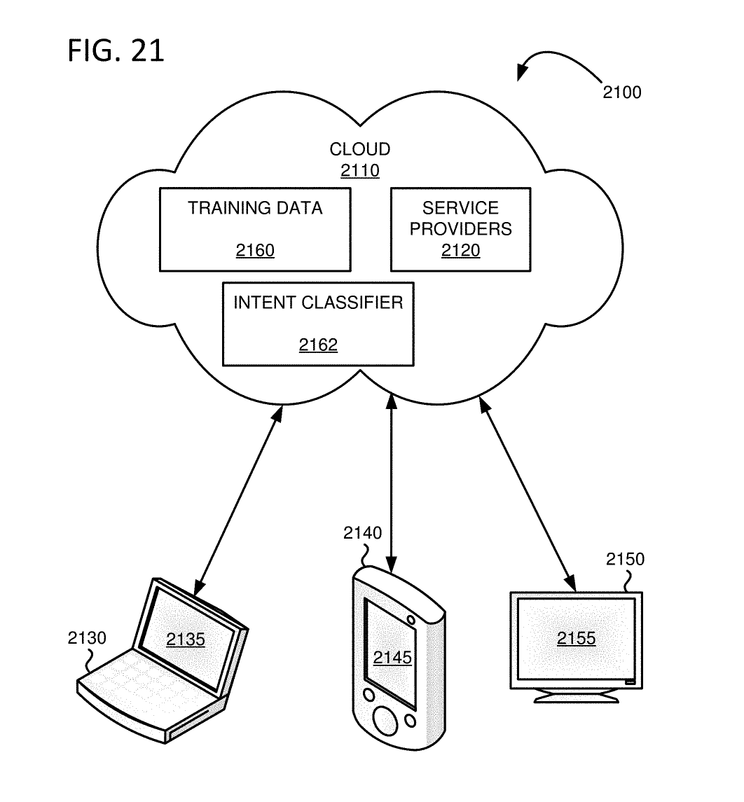

FIG. 20 is a system diagram depicting an example mobile device 2000 including a variety of optional hardware and software components, shown generally at 2002. Any components 2002 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 2004, such as a cellular, satellite, or other network.

The illustrated mobile device 2000 can include a controller or processor 2010 (e.g., signal processor, microprocessor, ASIC, or other control and processing logic circuitry) for performing such tasks as signal coding, data processing, input/output processing, power control, and/or other functions. An operating system 2012 can control the allocation and usage of the components 2002 and support for one or more application programs 2014. The application programs can include common mobile computing applications (e.g., email applications, calendars, contact managers, web browsers, messaging applications), or any other computing application. The application programs 2014 can also include virtual keyboard, task icon, and user interface reconfiguration technology. Functionality 2013 for accessing an application store can also be used for acquiring and updating application programs 2014.

The illustrated mobile device 2000 can include memory 2020. Memory 2020 can include non-removable memory 2022 and/or removable memory 2024. The non-removable memory 2022 can include RAM, ROM, flash memory, a hard disk, or other well-known memory storage technologies. The removable memory 2024 can include flash memory or a Subscriber Identity Module (SIM) card, which is well known in GSM communication systems, or other well-known memory storage technologies, such as “smart cards.” The memory 2020 can be used for storing data and/or code for running the operating system 2012 and the applications 2014. Example data can include web pages, text, images, sound files, video data, or other data sets to be sent to and/or received from one or more network servers or other devices via one or more wired or wireless networks. The memory 2020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 2000 can support one or more input devices 2030, such as a touchscreen 2032, microphone 2034, camera 2036, physical keyboard 2038 and/or trackball 2040 and one or more output devices 2050, such as a speaker 2052 and a display 2054. Other possible output devices (not shown) can include piezoelectric or other haptic output devices. Some devices can serve more than one input/output function. For example, touchscreen 2032 and display 2054 can be combined in a single input/output device.

The input devices 2030 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 2012 or applications 2014 can comprise speech-recognition software as part of a voice user interface that allows a user to operate the device 2000 via voice commands. Further, the device 2000 can comprise input devices and software that allows for user interaction via a user's spatial gestures, such as detecting and interpreting gestures to provide input to a gaming application.

A wireless modem 2060 can be coupled to an antenna (not shown) and can support two-way communications between the processor 2010 and external devices, as is well understood in the art. The modem 2060 is shown generically and can include a cellular modem for communicating with the mobile communication network 2004 and/or other radio-based modems (e.g., Bluetooth 2064 or Wi-Fi 2062). The wireless modem 2060 is typically configured for communication with one or more cellular networks, such as a GSM network for data and voice communications within a single cellular network, between cellular networks, or between the mobile device and a public switched telephone network (PSTN).

The mobile device can further include at least one input/output port 2080, a power supply 2082, a satellite navigation system receiver 2084, such as a Global Positioning System (GPS) receiver, an accelerometer 2086, and/or a physical connector 2090, which can be a USB port, IEEE 1394 (FireWire) port, and/or RS-232 port. The illustrated components 2002 are not required or all-inclusive, as any components can be deleted and other components can be added.

### Example Cloud-Supported Environments

FIG. 21 illustrates a generalized example of a suitable cloud-supported environment 2100 in which described embodiments, techniques, and technologies may be implemented. In the example environment 2100, various types of services (e.g., computing services) are provided by a cloud 2110. For example, the cloud 2110 can comprise a collection of computing devices, which may be located centrally or distributed, that provide cloud-based services to various types of users and devices connected via a network such as the Internet. The implementation environment 2100 can be used in different ways to accomplish computing tasks. For example, some tasks (e.g., processing user input and presenting a user interface) can be performed on local computing devices (e.g., connected devices 2130, 2140, 2150) while other tasks (e.g., storage of data to be used in subsequent processing) can be performed in the cloud 2110.

In example environment 2100, the cloud 2110 provides services for connected devices 2130, 2140, 2150 with a variety of screen capabilities. Connected device 2130 represents a device with a computer screen 2135 (e.g., a mid-size screen). For example, connected device 2130 can be a personal computer such as desktop computer, laptop, notebook, netbook, or the like. Connected device 2140 represents a device with a mobile device screen 2145 (e.g., a small size screen). For example, connected device 2140 can be a mobile phone, smart phone, personal digital assistant, tablet computer, and the like. Connected device 2150 represents a device with a large screen 2155. For example, connected device 2150 can be a television screen (e.g., a smart television) or another device connected to a television (e.g., a set-top box or gaming console) or the like. One or more of the connected devices 2130, 2140, 2150 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 2100. For example, the cloud 2110 can provide services for one or more computers (e.g., server computers) without displays.

Services can be provided by the cloud 2110 through service providers 2120, or through other providers of online services (not depicted). For example, cloud services can be customized to the screen size, display capability, and/or touchscreen capability of a particular connected device (e.g., connected devices 2130, 2140, 2150).

In example environment 2100, the cloud 2110 provides the technologies and solutions described herein to the various connected devices 2130, 2140, 2150 using, at least in part, the service providers 2120. For example, the service providers 2120 can provide a centralized solution for various cloud-based services. The service providers 2120 can manage service subscriptions for users and/or devices (e.g., for the connected devices 2130, 2140, 2150 and/or their respective users). The cloud 2110 can store training data 2160 used in user intent determination as described herein. An intent classifier 2162, which can be, for example, similar to intent classifier 116 of FIG. 1, can also be implemented in cloud 2110.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 19, computer-readable storage media include memory 1920 and 1925 and storage 1940. By way of example and with reference to FIG. 20, computer-readable storage media include memory 2020, 2022, and 2024. The term computer-readable storage media does not include signals and carrier waves. In addition, the term computer-readable storage media does not include communication connections (e.g., 1970, 2060, 2062, and 2064).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

We claim:

1. A system, comprising:
at least one processor;
an intent classifier configured to, by the at least one processor:
determine one or more user intent candidates based on contextual information; and
a user interface generator configured to, by the at least one processor:
generate a virtual keyboard for display in a user interface, and
upon receiving an indication of a user intent determined based on the one or more user intent candidates, generate a task icon within the virtual keyboard based on the determined user intent, wherein interaction with the task icon in the virtual keyboard launches functionality associated with the determined intent.

2. The system of claim 1, wherein the contextual information comprises at least one of: text entered via the virtual keyboard, text received from a remote computing device, commands received through voice recognition, information relating to an application that is active while the virtual keyboard is displayed, task icons previously interacted with, location of a user interacting with the user interface, or a current time, day, or date.

3. The system of claim 2, wherein the application is a messaging application, and wherein the contextual information comprises text entered via the virtual keyboard while the messaging application is active or text received in the messaging application while the messaging application is active.

4. The system of claim 1, wherein the task icon is presented within an input method editor (IME) portion of the virtual keyboard.

5. The system of claim 1, wherein the user interface generator is further configured to, by the at least one processor and upon receiving an indication of an interaction with the task icon, replace a portion of the user interface with a task icon user interface, and wherein the functionality associated with the determined intent is accessible via the task icon user interface.

6. The system of claim 5, wherein the task icon user interface is displayed in place of a portion of the virtual keyboard.

7. The system of claim 5, wherein the task icon user interface is displayed in place of a portion of the user interface above the virtual keyboard, and wherein the virtual keyboard continues to be displayed while the task icon user interface is displayed.

8. The system of claim 5, wherein the task icon user interface comprises at least one of: an application user interface for an application launched by interaction with the task icon or a deep link to functionality of an application or functionality of a web service.

9. The system of claim 8, wherein the application launched by interaction with the task icon is one of: a mapping application, an organization application, a transactional service application, a media application, or a user review application.

10. The system of claim 8, wherein the application user interface for the application launched by interaction with the task icon comprises shareable content generated by the application and related to the determined intent, and wherein the shareable content is at least one of: an estimated arrival or departure time; an event start time or end time; a restaurant suggestion; a movie suggestion; a calendar item; a suggested meeting time or meeting location; transit information; traffic information; weather or temperature information; or an instant answer result.

11. The system of claim 1, wherein the user interface generator is further configured to, by the at least one processor, remove the task icon upon receiving an indication that the determined user intent has been updated based on additional contextual information.

12. The system of claim 1, wherein the system further comprises:
at least one additional intent classifier configured to determine, by the at least one processor, one or more additional user intent candidates based on the contextual information;
a ranker configured to, by the at least one processor:
rank the one or more user intent candidates, and
based on the ranking, select at least one of the user intent candidates as the determined user intent; and
and
a federator configured to, by the at least one processor:
distribute the contextual information to the intent classifier and to the at least one additional intent classifier; and
determine an aggregated group of user intent candidates based on the one or more user intent candidates determined by the intent classifier and the one or more additional user intent candidates determined by the at least one additional intent classifier, wherein the ranker is further configured to, by the at least one processor, rank the user intent candidates in the aggregated group.

13. The system of claim 1, wherein the virtual keyboard includes a search tool, and wherein the intent classifier is trained based on user input to the search tool and actions taken after corresponding results are provided by the search tool.

14. The system of claim 1, wherein the intent classifier is trained at least in part based on user interaction with, or lack of user interaction with, previously presented task icons.

15. A method for reconfiguring a user interface on a computing device, the method comprising:
presenting a virtual keyboard in the graphical user interface;
receiving one or more text entries;
based at least in part on the one or more text entries, determining a user intent using one or more intent classifiers;
upon determining the user intent, presenting, within the virtual keyboard, a task icon representing functionality corresponding to the user intent; and
after a user selection of the task icon or a user swipe of the task icon, presenting, in place of a portion of the graphical user interface, a task icon user interface that provides access to the functionality corresponding to the user intent.

16. The method of claim 15, wherein the task icon is presented within an input method editor (IME) portion of the virtual keyboard, and wherein the IME portion continues to be displayed while the task icon user interface is displayed.

17. The method of claim 15, wherein the task icon is presented either (i) in place of a portion of the virtual keyboard or (ii) in place of a portion of the graphical user interface above the virtual keyboard.

18. The method of claim 15, wherein the one or more text entries are part of a conversation in a messaging application, and wherein at least a portion of the conversation continues to be displayed while the task icon user interface is displayed.

19. The method of claim 15, wherein the virtual keyboard includes a search tool, and wherein the one or more intent classifiers are trained based on user input to the search tool and actions taken after corresponding results are provided by the search tool.

20. One or more computer-readable storage media storing computer-executable instructions for reconfiguring a graphical user interface, the reconfiguring comprising:
while a first application is active, presenting a virtual keyboard in the graphical user interface, the virtual keyboard having an input method editor (IME) portion;
based at least in part on contextual information for the first application, determining a user intent, the contextual information including at least one of text entered via the virtual keyboard, text received via the first application, or information relating to the first application;
presenting a task icon within the IME portion of the virtual keyboard, the task icon being linked to functionality reflecting the user intent; and
upon receiving an indication of a selection of the task icon or an indication of a swipe of the task icon, presenting, in place of a portion of the virtual keyboard, a task icon user interface, and wherein the task icon user interface comprises at least one of: an application user interface for a second application, shareable content generated by the second application, or a deep link to functionality of the second application or functionality of a web service.
